(19) United States
(12) Patent Application Publication
(10) Pub. No.: US 2017/0129602 A1
(43) Pub. Date: May 11, 2017

(54) Multipurpose Robotic System

(71) Applicant: M3N, Inc., San Jose, CA (US)

(72) Inventors: Maan Alduaiji, San Jose, CA (US); Abdullah Almasoud, Ames, IA (US); Mostafa Abdulla, Rancho Cordova, CA (US); Cameron Rose, Berkeley, CA (US)

(21) Appl. No.: 15/345,912

(22) Filed: Nov. 8, 2016

Related U.S. Application Data
(60) Provisional application No. 62/253,571, filed on Nov. 10, 2015.
(60) Provisional application No. 62/346,424, filed on Jun. 6, 2016.

(51) Int. Cl. B64C 39/02; G06Q 20/10; B08B 1/04; B60S 3/06; B08B 3/02; B08B 5/04; G05D 1/10; G06Q 30/02

(52) U.S. Cl. CPC B64C 39/024; G05D 1/104; G06Q 20/102; G06Q 30/0251; B60S 3/06; B08B 3/02; B08B 5/04; B08B 1/04; B64C 2201/12

(57) ABSTRACT

A multipurpose robotic system that includes an unmanned aerial vehicle that is able to fly under its own power to a location of a parked vehicle. A cleaning module is attachable to the unmanned aerial vehicle. The cleaning module is configured to take part in cleaning the parked vehicle. The cleaning module including a rotating brush configured to clean the vehicle

### BACKGROUND

Mobile robots can be implemented as vehicles that freely roam on a surface using, for example, wheels, track treads, and so on. Mobile robots can also be implemented as vehicles that that travel on tracks that are laid out on the ground or suspended overhead. Mobile robots can also be implemented as drones that are able to move around using propeller or jet propulsion. Mobile robots also be can be implemented as other types of robots, including, for example, those that travel in water.

### BRIEF DESCRIPTION OF THE DRAWINGS

FIG. 1 is a simplified block diagram for the multipurpose robotic system in accordance with an implementation.

FIG. 2 is a simplified diagram for the control system in accordance with an implementation.

FIG. 3 is a simplified diagram showing two types of robots in accordance with an implementation.

FIG. 4 is a simplified diagram of a “ground” robot with an attached extension module in accordance with an implementation.

FIG. 5 is a simplified diagram showing sections of a station in accordance with an implementation.

FIG. 6 is a simplified diagram providing additional details of sections of a station in accordance with an implementation.

FIG. 7 is a simplified diagram of a single rotating brush used in a cleaning module used for vehicle washing in accordance with an implementation.

FIG. 8 is a simplified diagram showing use of gears within a cleaning module used for vehicle washing in accordance with an implementation.

FIG. 9 is a simplified diagram illustrating brushes arranged within a replaceable cleaning module in accordance with an implementation.

FIG. 10 is a simplified block diagram of a snow removal extension module used to remove snow from vehicles in accordance with an implementation.

FIG. 11 is a simplified block diagram of a vehicle cleaning extension module in accordance with an implementation.

FIG. 12 is a simplified diagram showing a multipurpose robotic system extension module attached to a robot in accordance with an implementation.

FIG. 13 is a simplified diagram showing a snow removal module used to remove snow from vehicles in accordance with an implementation.

FIG. 14 is a simplified diagram of a snow removal module without mounted big replaceable rotating brushes in accordance with an implementation.

FIG. 15 is a simplified diagram of a robot equipped with a vehicle cleaning extension module in accordance with an implementation.

FIG. 16 is a simplified diagram of a robot equipped with a vehicle cleaning extension module that has open metal arms in accordance with an implementation.

FIG. 17 is a simplified diagram of a robot equipped with a vehicle cleaning extension module in accordance with an implementation.

FIG. 18 is a simplified diagram of a robot equipped with a vehicle cleaning extension module that does not have mounted replaceable big rotating brushes in accordance with an implementation.

FIG. 19 is a simplified diagram of a robot equipped with a vehicle cleaning extension module that has a vacuum to remove leafs and other things in accordance with an implementation.

FIG. 20 is a simplified diagram of a robot equipped with a vehicle cleaning extension module that has a small rotating brush in accordance with an implementation.

FIG. 21 is a simplified diagram of a big replaceable rotating brush with an electronic sprayer in accordance with an implementation.

FIG. 22 is a simplified diagram of a station that has an outside screen and a small range communication “beacon” in accordance with an implementation.

FIG. 23 is a simplified diagram of a module with a side advertisement screen in accordance with an implementation.

FIG. 24 is a simplified diagram of a robot with an NFC small range network used for making payments in accordance with an implementation.

FIG. 25 is a simplified diagram of a robot equipped with a vehicle cleaning extension module that has a dirt sensor in accordance with an implementation.

FIG. 26, FIG. 27, FIG. 28A, FIG. 28B, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, FIG. 42, FIG. 43 and FIG. 44 are simplified flowcharts that illustrate tasks performed by a multi-purpose robotic system in accordance with implementations.

### DETAILED DESCRIPTION

This description herein incorporates by reference all the subject matter disclosed in provisional application No. 62/253,571, filed on Nov. 10, 2015 and provisional application No. 62/346,424, filed on Jun. 6, 2016.

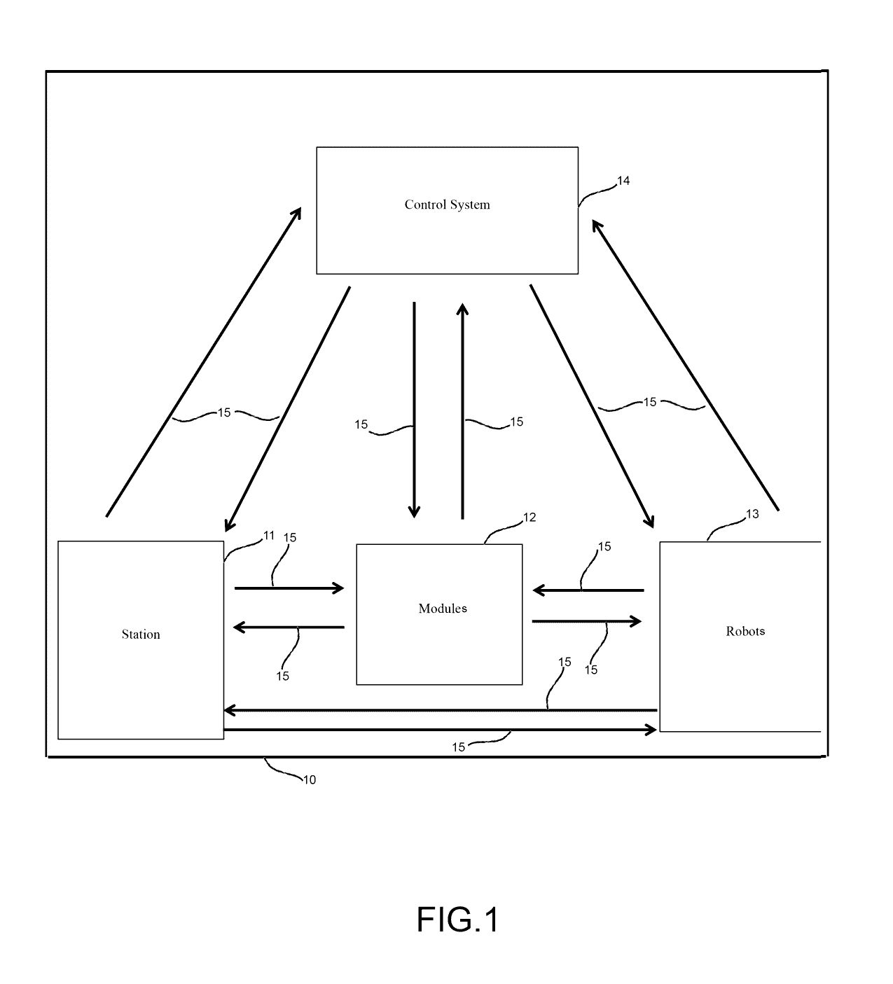

FIG. 1 shows a multipurpose robotic system 10 that includes a control system 14, stations 11, robots 13 and extension modules 12. Stations 11 include housing for robots 13 and extension modules 12. There may be one or more stations 11, robots 13 and extension modules 12.

Each of extension modules 12 may be configured to perform one or more tasks. For example, an extension module can be configured as a cleaning module used to clean a vehicle or perform some other cleaning service. For example, a cleaning module can be used for snow removal or to vacuum dirt, leaves and so on. For example, an extension module can also be configured as a sales module to provide information to and receive orders from a customer. Alternatively, an extension module can be configured as a vacuum module, a dirt sensor module, or some other type of extension module.

Control system 14 includes the hardware and the software that manages, controls, and monitors the requests and tracks the progress of the services provided by robots 13 with extension modules 12 and without extension modules 12 and stations 11. In addition, control system 14 manages the safety of multipurpose robotic system 10 and checks all parts of multipurpose robotic system 10 and provides component status. Each part of multipurpose robotic system 10 periodically sends its status to control system 14. As represented by arrows 15, stations 11, robots 13 and extension modules 12 each may have a direct communication link with control system 14 and with each

Control system 14 receives service requests from customers. For example, the customer uses a computing device such as a personal computer, laptop computer, smart phone or tablet to make a service request from control system 14. For example, the service request is a request to schedule a service to be performed for the customer.

Control system 14 initiates and runs tasks and requests. The services are performed by one or more of robots 13 and one or more of extension modules 12. Control system 14 communicates with stations 11, robots 13 and extension modules 12. communicate with control system 14 through connections to the robots 13. Each of robots 13 relay notifications and messages to any extension module connected to the robot. Alternatively, extension modules 12 can be in direct communication with control system 14. Such direct communication, for example, allows functionality like displays on a display screen of an extension to be controlled directly by an extension module without the necessity of going through a robot.

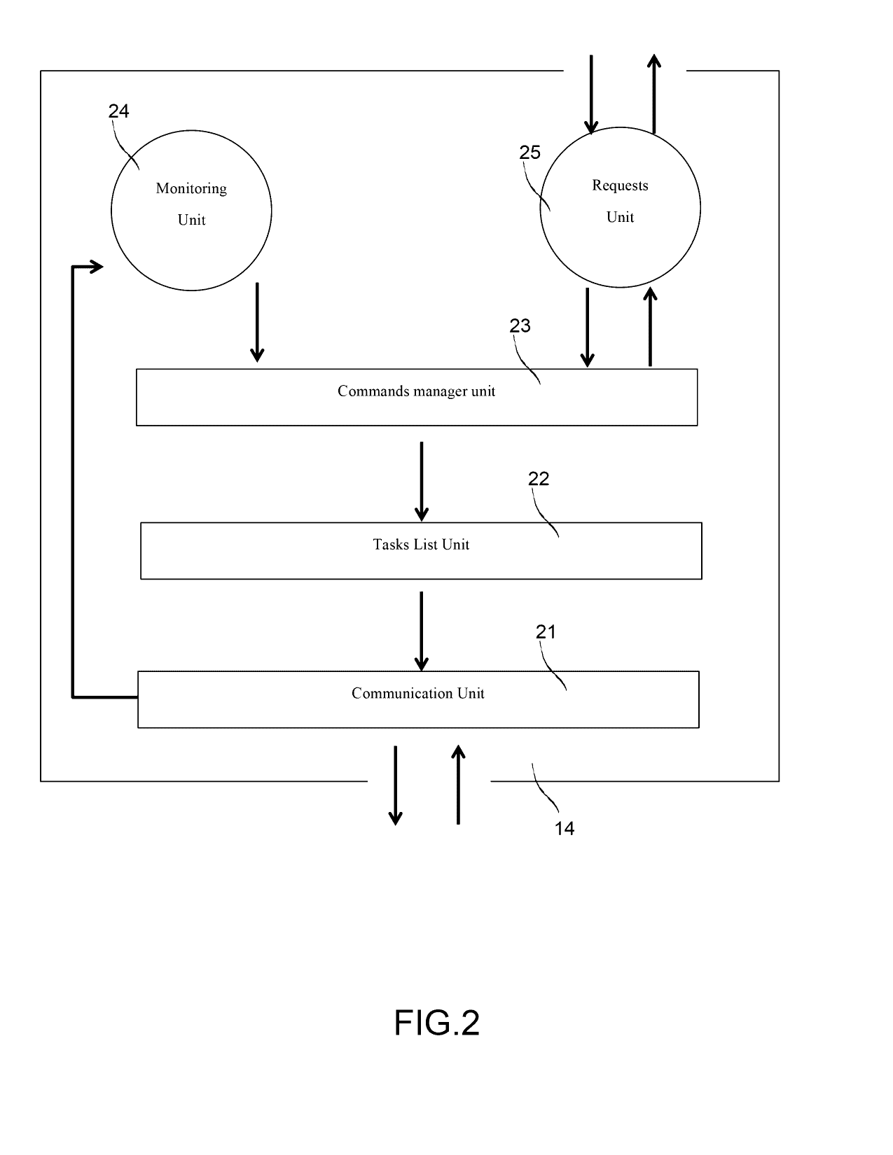

FIG. 2 shows control system 14 including a monitoring unit 24, a request unit 25, a commands manager unit 23, a tasks list unit 22 and a communication unit 231. This configuration of units within control system 14 may vary based on application, as in some applications a different mix of units with varying functionality may be used to implement control system 14.

Managing unit 24 is responsible for collecting periodically the data that comes from the components of multipurpose robotic system 14. The collected data is presented to commands manager unit 23. Commands manager unit 23 is responsible for analyzing and creating sub tasks and commands to the system parts. A task list unit 22 is responsible for listing and queuing all tasks that come from commands manager unit 23. Commands manager unit 23 prioritizes tasks according to system needs, system interruptions, emergency, or safety concerns. Communication unit 21 is responsible for receiving data from components of multipurpose robotic system 10 and sending tasks and commands to robots 13 and where allowed, to extension modules 12. Requests unit 25 communicates with the customers. The communications include reception of requests and sending notifications and messages.

Robots 13 are implemented, for example, as unmanned aerial vehicles (UAVs, i.e., drones), unmanned ground vehicles (UGVs) or as unmanned aerial system (UASs). Other types of robots may also be used.

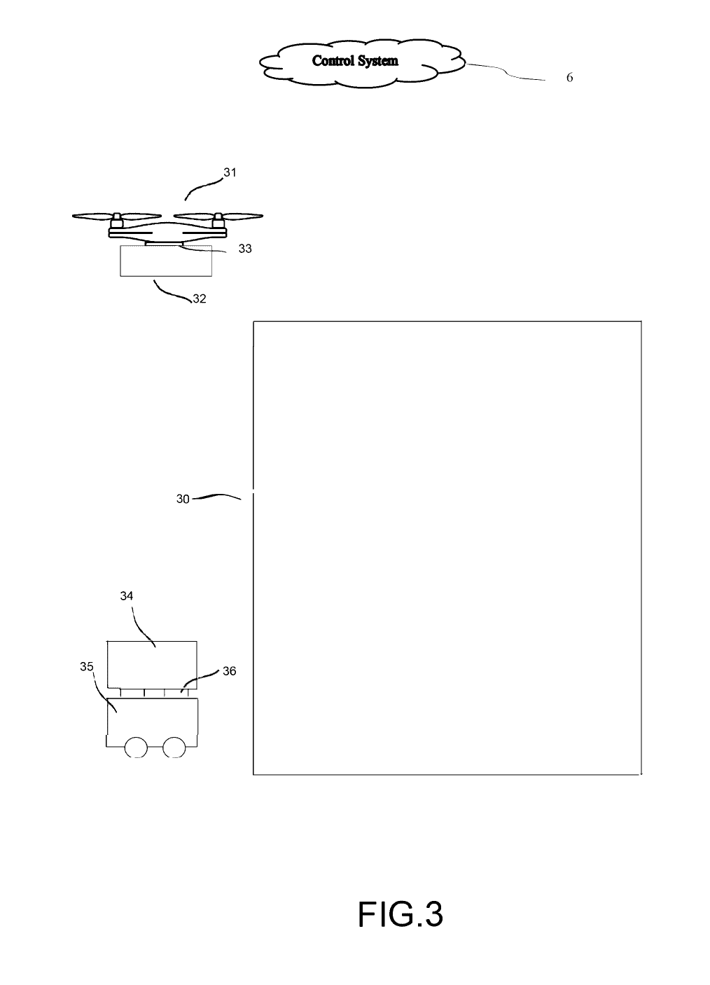

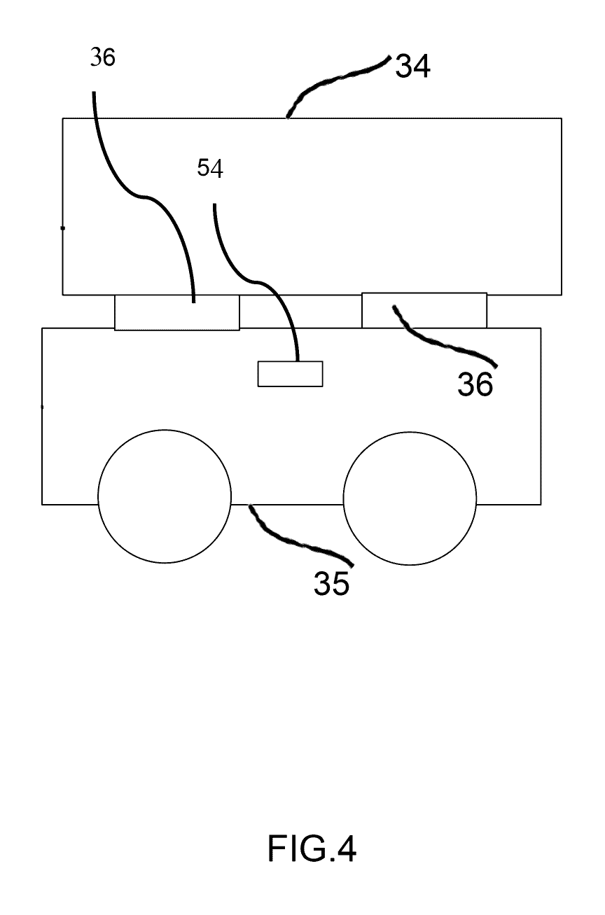

Robots and the extension modules are attached to each other, for example, mechanically or magnetically, using an attachment mechanism. For example, FIG. 3 shows a robot 31 connected to an extension module 32 through an attachment mechanism 33. For example, the attachment is made a mechanical connector such as a latch, or another mechanical device. Alternatively, attachment mechanism 33 is implemented using magnets or some other mechanical or electrical device. FIG. 3 also shows a ground vehicle 35 connected to an extension module 34 through an attachment mechanism 36. For example, the attachment is made a mechanical connector such as a latch, or another mechanical device. Alternatively, attachment mechanism 36 is implemented using magnets or some other mechanical or electrical device.

Examples of the extension modules 12 include but are not limited to cleaning modules, delivery modules, vacuum modules, dirt detection modules or other types of modules as further described below.

Communication between robots and extension modules can be accomplished wirelessly or wired. For example, FIG. 4, shows a wireless communication device 54 within ground vehicle 35.

The components of robots vary based on anticipated application. They components can include, for example, engines, batteries, computer devices, navigation systems, cameras, video recorders, sensors and any other device helpful to accomplish tasks intended to be performed by the robots.

Depending on applications, each of robots 13 is equipped with appropriate safety and emergency systems to prevent any harm and damage to people or property. As appropriate, warning systems are included within each of robots 13 to provide warning before there is any potential any harm or damage to people or property. Examples of safety components include, for example, parachutes, audio alarms, emergency lighting and other safety components that are anticipated to be appropriate based on the intended use of each of robots 13.

For example, components not related to movement or safety are located in extension modules 12. Extension modules 12 include, for example, communication functionality to communicate with an attached robot and/or control system 14. Each of extension modules 12 can also have additional safety systems, for example, to continue to provide protection in events such as when an extension module separates from a robot. Examples of safety components include, for example, parachutes, audio alarms, emergency lighting and other safety components that are anticipated to be appropriate based on the intended use of each of extension modules 12. When communication between a robot and an attached extension module is lost, or there is a malfunction or other unexpected event, the robot will return the extension module to an appropriate station.

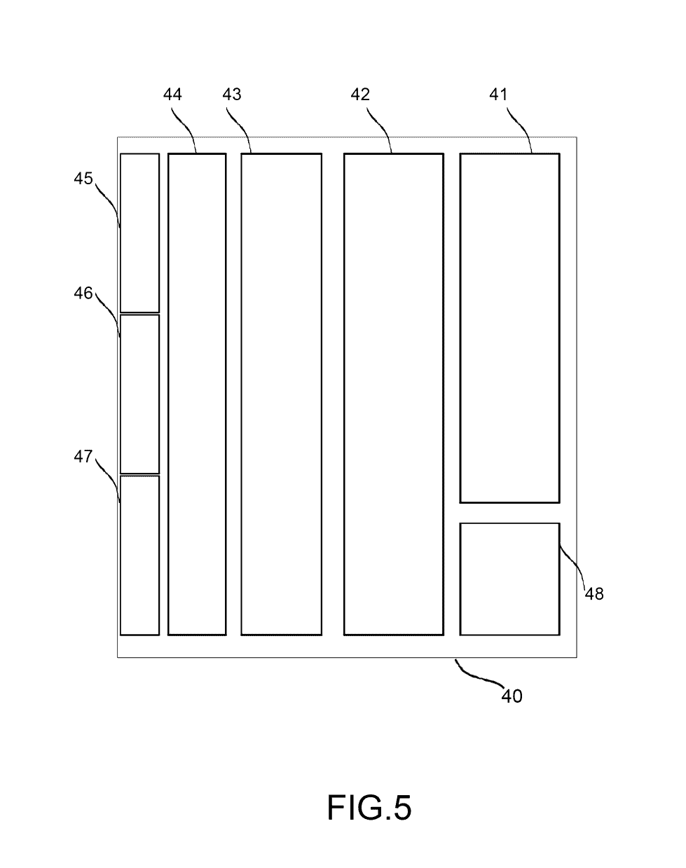

FIG. 5 shows additional detail of station 40, which is one of stations 11. Station 40 includes, for example, launch areas for launching and receiving robots, housing, and preparing places for robots and extension. Stations can be portable and located on vehicles such as, but not limited to, trucks or boats. Also, stations can be based at a stationary location such as a building. Stations are divided into sections as is illustrated by FIG. 5.

For example, a section 43 is a preparing section used for readying robots and extension modules. A section 41 is a robot room for storing robots. A section 42 is used to store containers. A section 44 is used to store extension modules. A section 46 is used to house one or more computer devices. A section 46 is used to house navigation systems and communication devices. A section 47 is used to house power supplies and generators, including batteries, generators and other sources of power. A section 48 is a fuel room used to fuel hybrid or gas powered robots.

Station 40 can have a backup generator or battery in case of an emergency power outage. Station 40 can have solar panels installed to charge the battery in station 40. The order and placement of sections in station 40 is exemplary. There is no required placement or order for the sections in station 40.

Further, the sections can be in one station or can be separated among multiple stations. For example, the preparing section can be in one station and robot rooms can be in another station. When the sections are separated in multiple stations, the system parts should have access to the sections housed in other stations by methods such as, but not limited, to doors to enable the retrieval of extension modules, robots, and items carried by extension modules and robots to use the service of the section. The number of elements in every section can be singular or multiple. For example, the preparing section can have one or multiple devices. For example, stations can have one or multiple identical sections. For example, a single station can have one or multiple preparing sections.

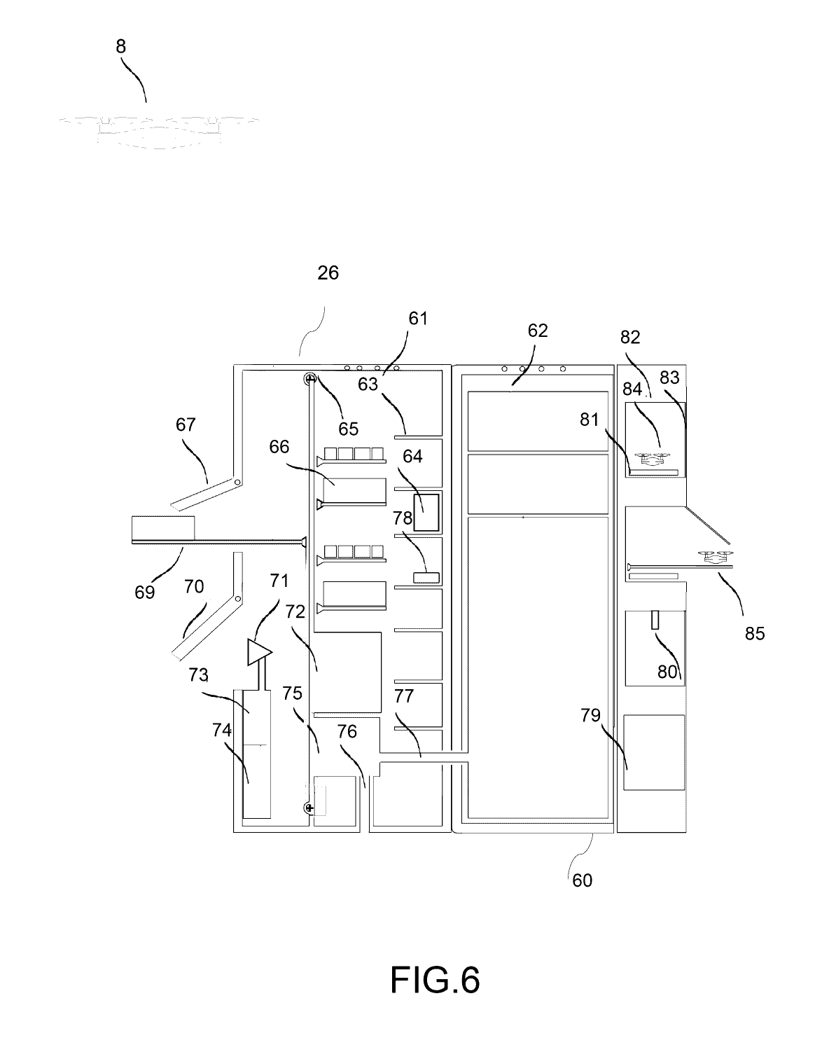

FIG. 6 suggests some of the flexibility possible when designing and implementing an exemplary station 60. To move extension modules, robots or any items inside a station, the station may have one or multiple moving mechanisms. For example, FIG. 6 shows a conveyer system 65 used to move a holder 69. Alternatively, a moving mechanism can be a robot such as, but not limited to, an unmanned ground vehicle. The robot can carry and move extension modules and items between sections in one or multiple rooms in a building. Extension modules and robots can attach to or detach from each other inside or outside station 60.

Stations have communication devices such as, but not limited to, 4G networks to communicate with the system, robots and extension modules. Stations have navigation devices such as, but not limited to, global positioning systems (GPS) to enhance locating and navigation functionality. Some sections can have designated doors to access and exit to enable robots to deliver extension modules and items directly to the section. In this case, the section could have a separate moving mechanism inside the section.

For example, station 60 has an empty spot 79 to enable robots to make safe stops in case of emergency cases. Also, a station can have a separate control station to autonomously control both robots and extension modules. A station can have a section to enable customers to order services directly from the station site. For example, a touchscreen can enable customers to order services directly from station 60. For example, a limited range network such as, but not limited to, a near field communication (NFC) chip can be used to enable customers to order the services when they are close to station 60 using their computer devices.

For example, station 60 has a section used to fill one or more containers 74 with liquid. One or multiple valves 71 are used as are one or multiple pumps 73 or any other mechanisms to move liquids to fill the extension modules or the robots or to use liquid in preparing processes in the devices in the preparing section such as, but not limited to, cleaning extension modules. Station 60 includes one or more doors 70 used to fill the stations with extension modules or replace them. For example, station 60 has a door 67 used to fill or receive extension modules or items from the robots. Stations have extra space in the preparing section and other sections as needed to facilitate station activity. For example, station 60 has one or more computer devices and systems to run and manage operations.

If a robot (with or without an extension module or an item carried by robots and extension modules) returns to a station and the station does not respond to control system 14 or the station has one or multiple failure notifications from elements that receives robots and extension modules (such as, but not limited to, station doors for extension modules and robots), the robot can stop at an emergency spot in the station. If there is any problem with the station such as, for example, the station being unable to open a door to let a robot launch, control system 14 will redirect the command to another station. In case of emergency in the station such as a fire, the station evaluates the situation. If the emergency situation is a manageable situation and the station is able to release the robots out of the station, the station sends a command to all robots to leave the station. If the emergency situation is a manageable situation and the station is able to release the robots and the extension modules, the station sends a command to all robots to pick up one or multiple extension modules before leaving the station. When an extension module malfunctions or the station does not have the extension module for the service, control system 14 sends a robot to pick up the extension module from its housing location and take it to a service area.

The purpose of a preparing section is to prepare extension modules for the next service or to prepare items carried by the extension modules and robots, such as delivery items. The preparing process can be accomplished at any time. The preparing process is not limited to specific processes or actions. The preparing processes can include, for example, cleaning, scanning, sanitizing, filling extension modules with liquid. In station 60, a preparing section 61 can have one or multiple preparing devices represented by a preparing device 72 and a preparing device 75. For example, a preparing device can be a scanning device such as an X-RAY device. Preparing devices such as washers and dryers can be used to wash extension modules or items carried by extension modules and robots. Other preparing devices can be sanitizing devices that clean extension modules or the items carried by the extension modules. Other preparing section devices can be used for replacing batteries device for the robots and modules. The preparing section devices can be located inside or outside the station. For example, preparing section devices can be on the roof of the station or at other locations. Various other types of preparing devices also can be utilized.

Every device in the preparing section can have one or multiple functions. For example, a washer and dryer used for washing and cleaning extension modules, can also be used to get rid of waste from a waste container within the extension modules. The purpose of scanning the extension modules and items carried by extension modules and robots is to identify all of the items of the extension module. Extension modules and items carried by extension modules and robots can use one or multiple preparing devices in order to be ready to next services. In the case where the preparing section in the station has more than the expected number of extension modules or the expected number of another other item carried by a robot or an extension, control system 14 can direct a robot to deliver a missing extension module or item carried by the robot and extension module from another station

A containers section 62 has one or multiple containers filled with liquid such as soap, water, fuel, waste material or other types of liquids or solid items. Containers section 62 can also contain moving mechanisms to move the container or for the solid items. The purpose of the waste container is to receive waste from other sections such as, but not limited to, waste in waste storage 77 in preparing section 61. Station 60 includes one or more pipes 76 leading outside of station 60 to remove the waste from all the sections. Containers can have electronic or mechanical sensors to measure liquid levels. When a waste or another container is full, nothing more may be added until the container is no longer full.

A robot room 82 houses the robots, represented by a robot 24. A charger 81 is present for use when robots stored in robot room have batteries. For example, chargers attach to the robots using an attaching mechanism that operates through cables or wirelessly. The robot rooms can have an electronic holder or any other mechanisms to enable robots to make a successful launch without collision from a launching area 85. Filling area 80 can be used to provide fuel for hybrid or gas powered robots. A door 83 allows robots to enter and exit robot room 82. For example, robot rooms have sensors to check the availability, the stability, and the functionality of the robots. The access to robot rooms can be accomplished from inside or outside the stations.

Some extension modules need to be re-charged. Chargers 78 in preparing section 61 can be used to charge the extension modules. The chargers attach with the extension modules using attaching mechanism can be accomplished wirelessly or wired. For example, extension modules can be stored on shelves as represented by shelves 63 and extension module 64 and extension module 66.

Filling robots with fuel can be accomplished in a special section using electronic sprays or any other mechanism to fill the robots with fuel. The location of fuel room can be inside or outside the station such as, but not limited to, the stations' roof. The robots can go third party stations to fill the robot with fuel.

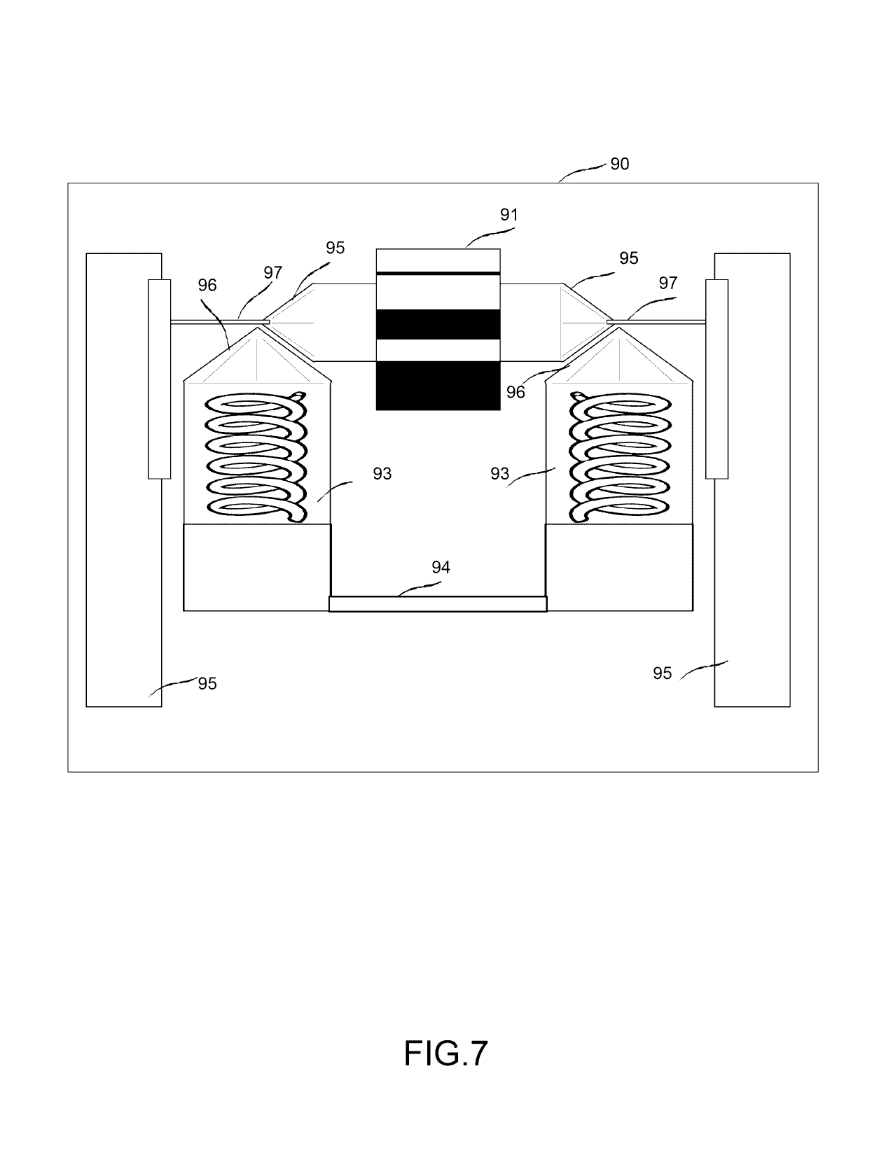

Extension modules can be configured to perform functions. For example, FIG. 7 shows configuration of a cleaning module 90 used for vehicle washing. For example, cleaning module 90 can be attached to an unmanned aerial vehicle or an unmanned ground vehicle. A rotating brush 91 mounted on an axel 97 is rotated by the interaction of gears 95 and 96 held together by springs 93. Gears 96 are rotated by a gear 94, which may be driven by a power source within cleaning module 90 or within a robot attached to cleaning module 90. Housing 98 and housing 99 provide support for axel 97.

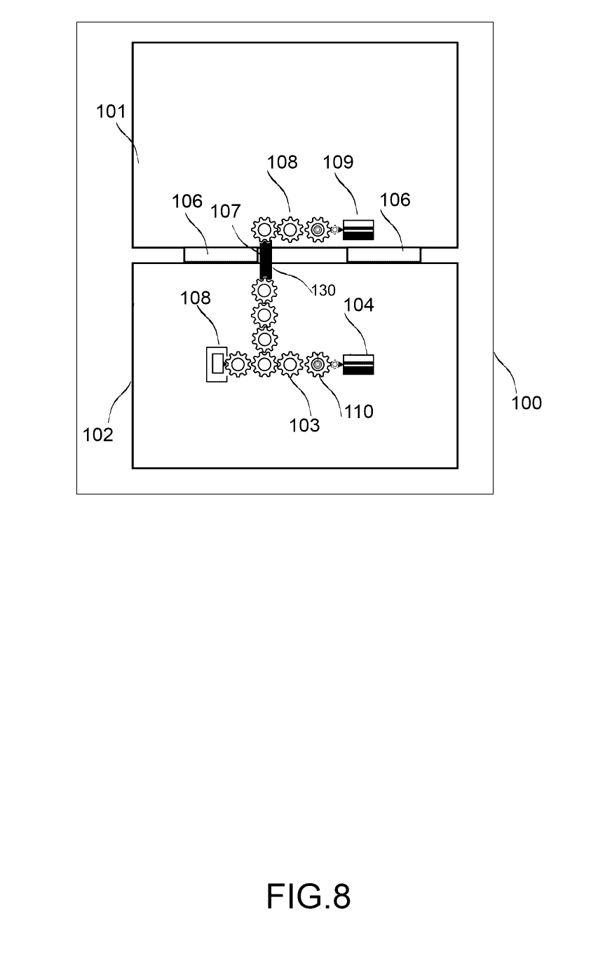

In FIG. 8, shows another example of a cleaning module 100 that has a section 101 and a section 102. While FIG. 8 shows two sections, this is illustrative as cleaning modules can have more than two sections. Also shown is a motor rotating brushes power door 105. Motor rotating brush power door 105 is located within metal arms. For example, gears are used to transfer the power from a motor 110 to a brush 104 and a brush 109. For example, gears 103 and gears 108 provide power to brush 104 and brush 109. A gear 107 transfers power from gears 103 within section 102 to gears 108 within section 101. For example, spring hinges 106 connect section 101 to section 102.

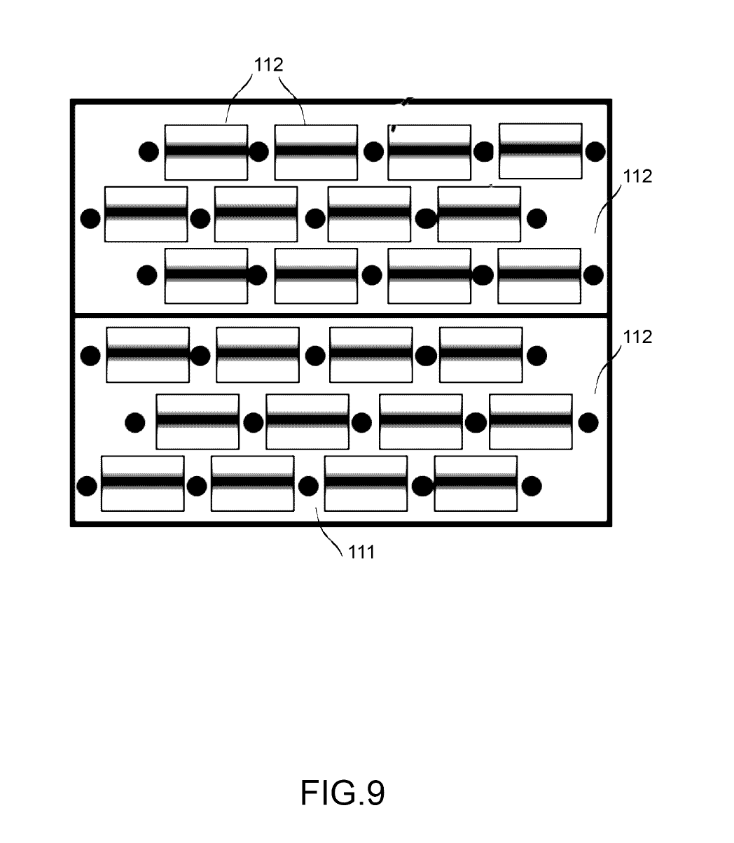

Multiple brushes may be mounted in a cleaning module. This is illustrated in FIG. 9 by a cleaning module 111, that has an array of twenty-four brushes 112.

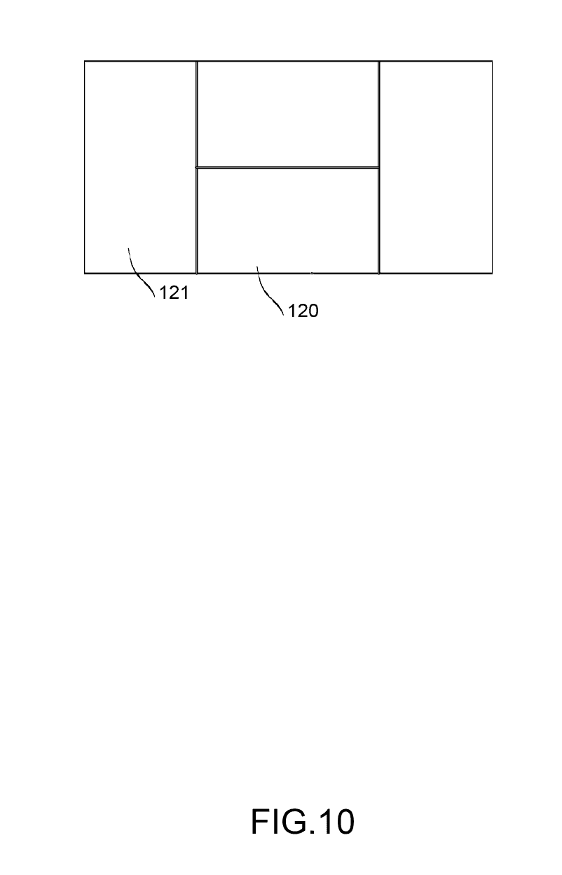

To aid in removing snow from vehicles, a container 120 can be included within a snow removal extension module, as shown in FIG. 10. Container 120 can carry water or some other liquid for helping to loosen and remove snow.

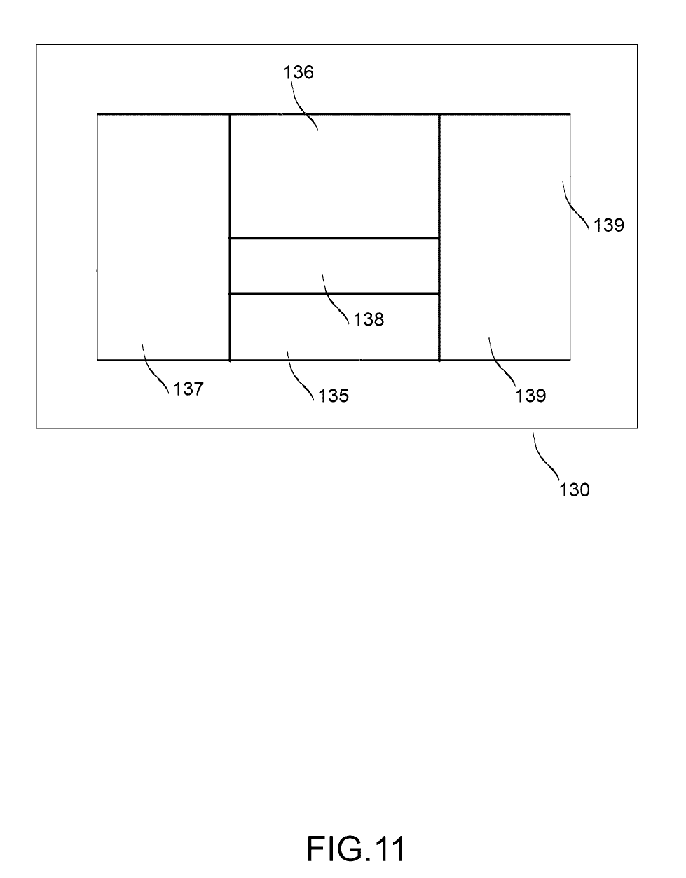

FIG. 11 presents additional detail of a snow removal extension module 130. Included within snow removal extension module 130 are a liquid container 135, a vacuum 136 and replaceable big rotating brushes 137 and 139, mounted on metal arms, for vehicle washing.

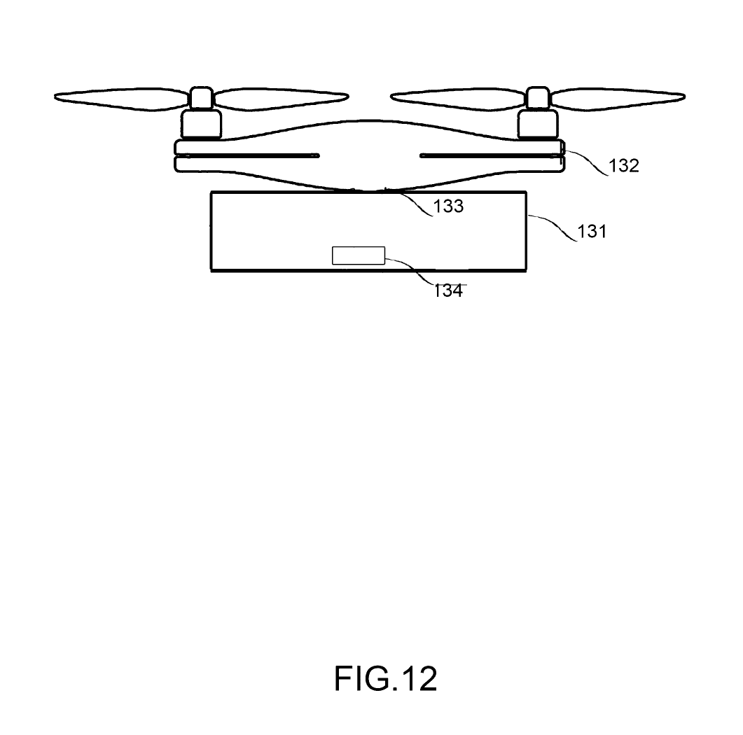

In FIG. 12, an extension module 131 is shown connected to a robot 132 by a mechanical or electrical (e.g. magnetic) attachment mechanism 133. A communication device 134 allows communication with other robots, a station, control system 14, extension module 131 and/or a customer. The communication between robots and extensions can be accomplished wirelessly or by using cables.

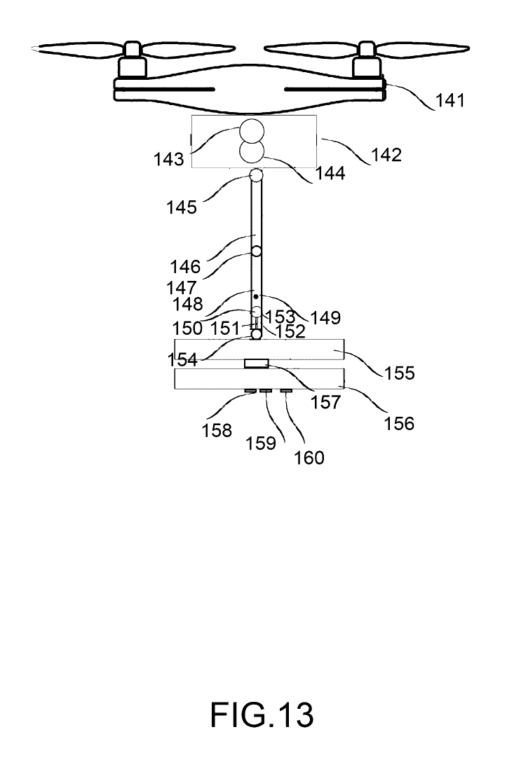

In FIG. 13, a snow removal module 142 is connected to a robot 141. For example, a snow removal module is a type of cleaning module. A distance sensor 149 is included within a metal arm having that includes pushing motors sections 146 and 148. Electric motors at a hinge 145 and a hinge 147 are additionally used to adjust configuration of the electric arm. Snow removing replaceable rotating brushes 156 are used to brush away snow. Lights 143 are used for night pictures or to help with vision. Also shown are a camera 144 and mechanical sensors 158 used for object detection. Electric sprayer 159 sprays liquid for snow removing. A mechanical hinge 154, or other type of joint is also shown. A snow sensor 160 is used to measure the snow and decide upon a method to remove snow. The method may utilize a combination or rotating brushes, snow removing liquid or other snow removing helps. Also shown are electric rotating motors 150, pushing and pulling motor 151 and a spring 152. Motor 103 is used to generate power to make snow rotating brushes rotate. Snow rotating brushes have mechanical gears and springs. Also, extension module 142 can a sensor 104 that uses ultrasonic, laser or any other mechanism to detect objects.

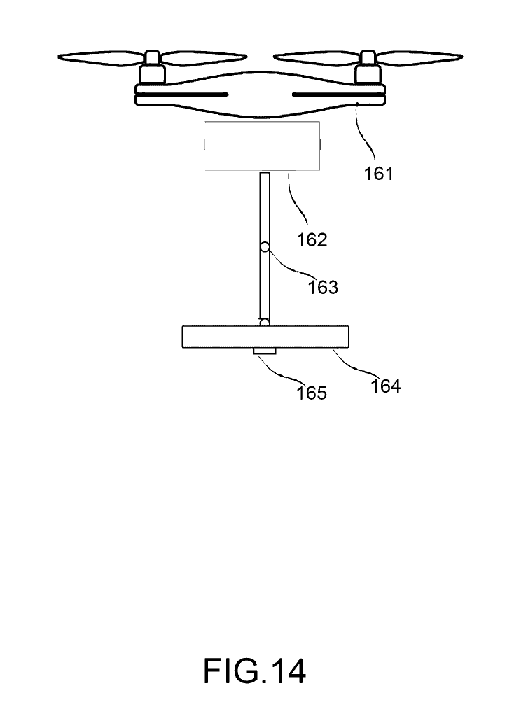

In FIG. 14 a robot 161 is attached to a snow removal module 162. A motorized arm 163 is connected to a brush 164 that includes a spray nozzle 165 used to spray liquid.

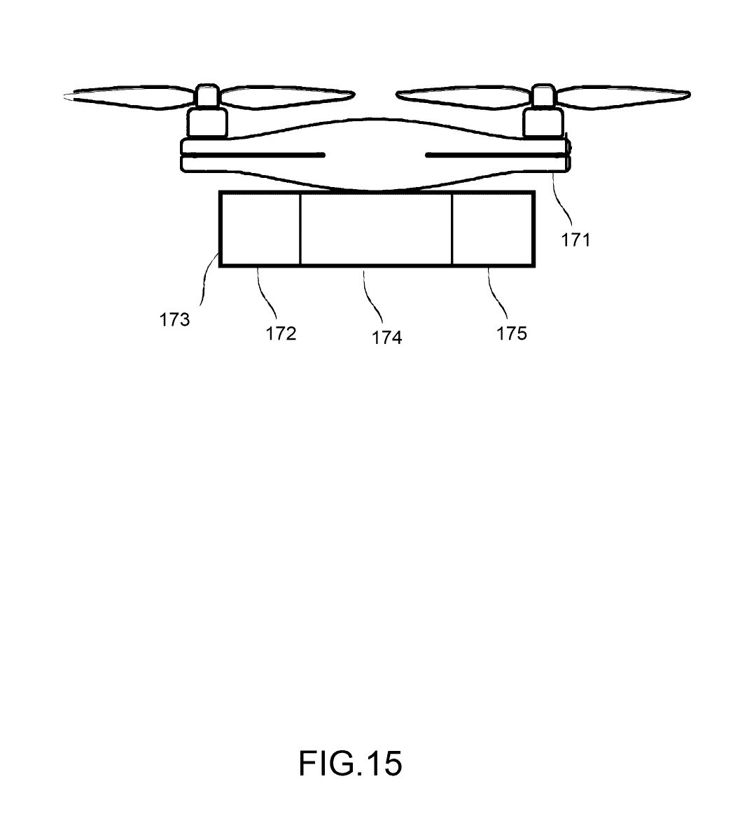

In FIG. 15, a robot 171 is connected to a cleaning extension module 172. Cleaning extension module 172 includes arms hidden from sight because they are closed within cleaning extension module 172.

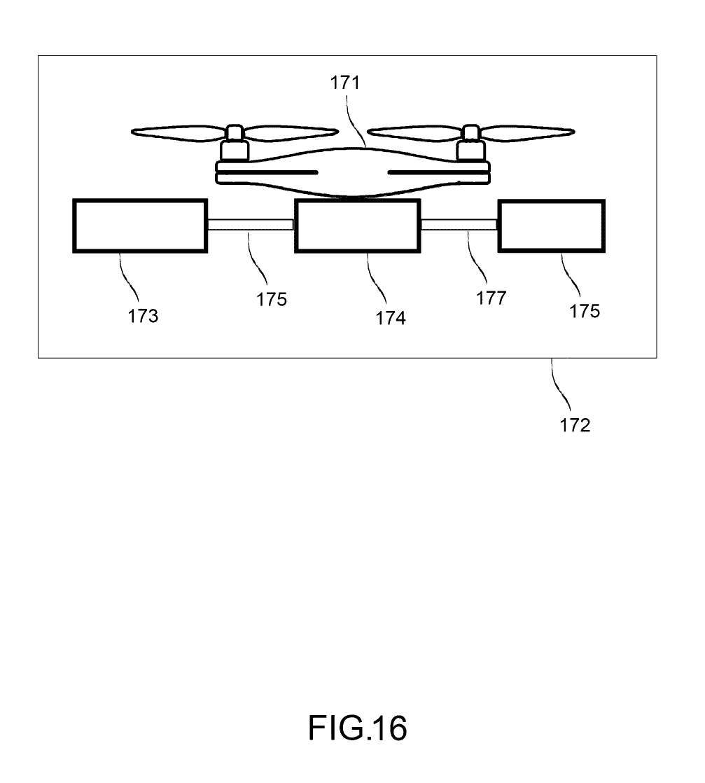

In FIG. 16, an arm 176 and an arm 177 have been opened separating section 173 and section 175 from section 174 of cleaning extension module 172. Arm 176 and arm 177 include pushing and pulling motors to facilitate opening and shutting cleaning extension module 172. Section 173 and section 175 include big replaceable rotating brushes for washing vehicles.

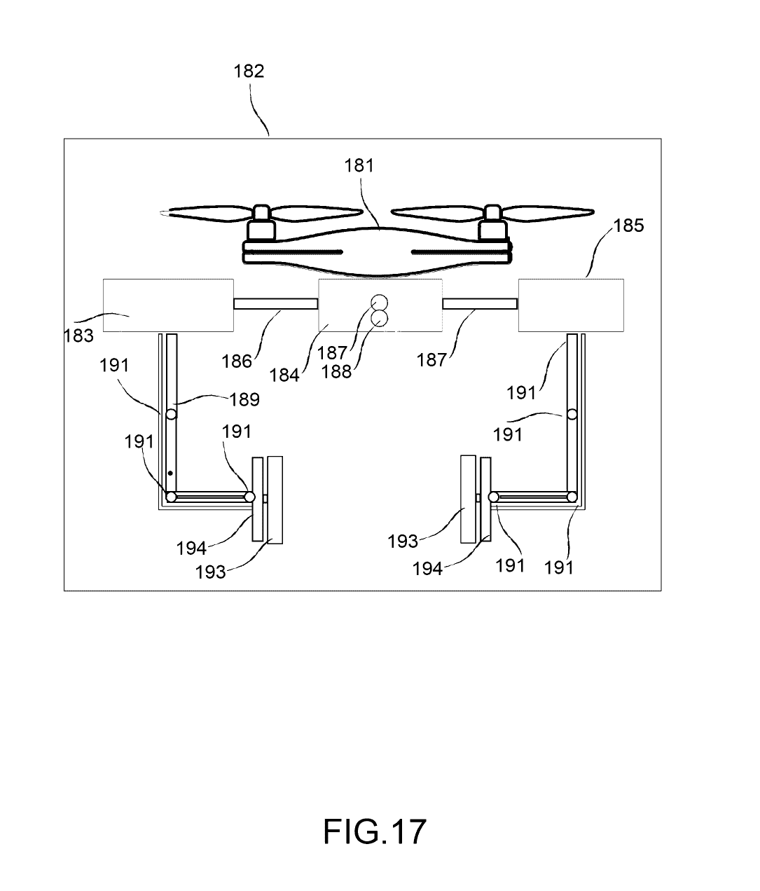

In FIG. 17, a robot 181 is connected to a cleaning extension module 182. Cleaning extension module 182 includes an arm 186 and an arm 187 that have been opened separating section 183 and section 185 from section 184 of cleaning extension module 182. Arm 186 and arm 187 include pushing and pulling motors to facilitate opening and shutting cleaning extension module 182. Section 183 and section 185 include big replaceable rotating brushes for washing vehicles.

Big replaceable rotating brushes 193 are used for vehicle washing. Extension module 182 also includes a camera 188, lights 188 for night or unclear vision, a sensor for objects detection such as ultrasonic, laser or any other mechanisms, rotating motors 191, spring hinges, washing liquid tubes, springs, a pulling motors, a mechanical sensor for detecting objects, a washing liquid electronic sprayer, distance sensors, pulling and pushing motors, a liquid level sensor to measure vehicle washing liquid level, a motor to generate power to make car-washing rotating brushes rotate, a motion detection sensor and speakers. The extension has one or multiple metal arms for washing. These arms have identical configuration or may be configured differently. A cleaning module can include a snow sensor, if desired.

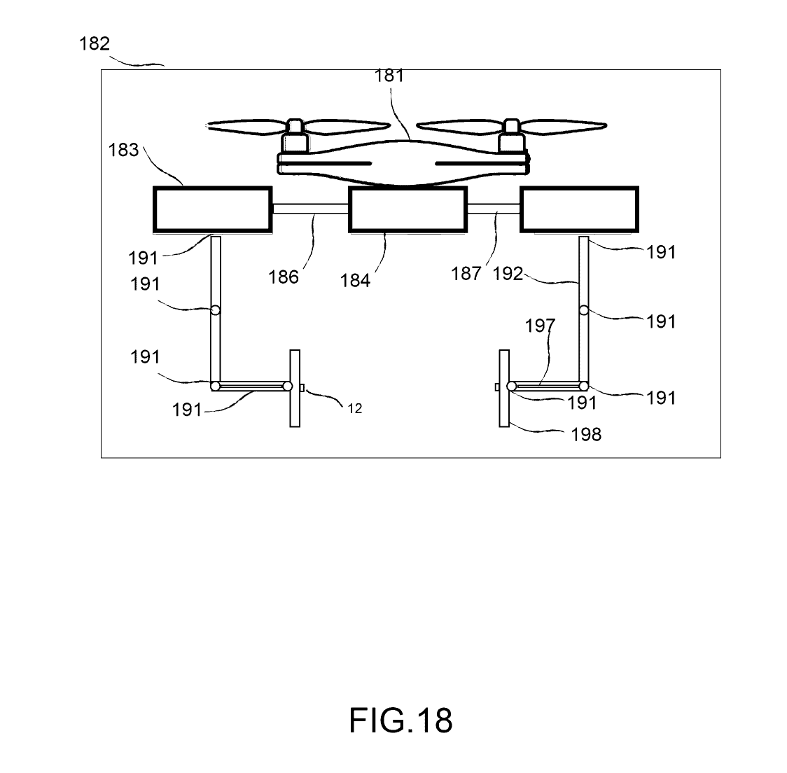

In FIG. 18, big replaceable brushes 193 have been removed from extension module 182.

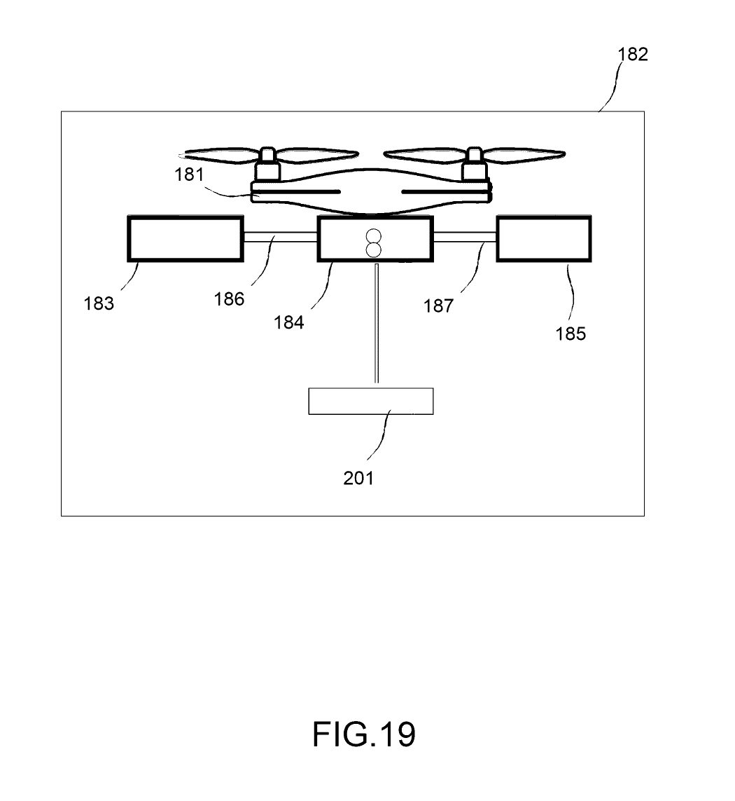

In FIG. 19, extension module 182 has been reconfigured to include a vacuum 201 to remove leafs, dirt and other objects. A vacuum module can be implemented in a separate module or combined with a cleaning module.

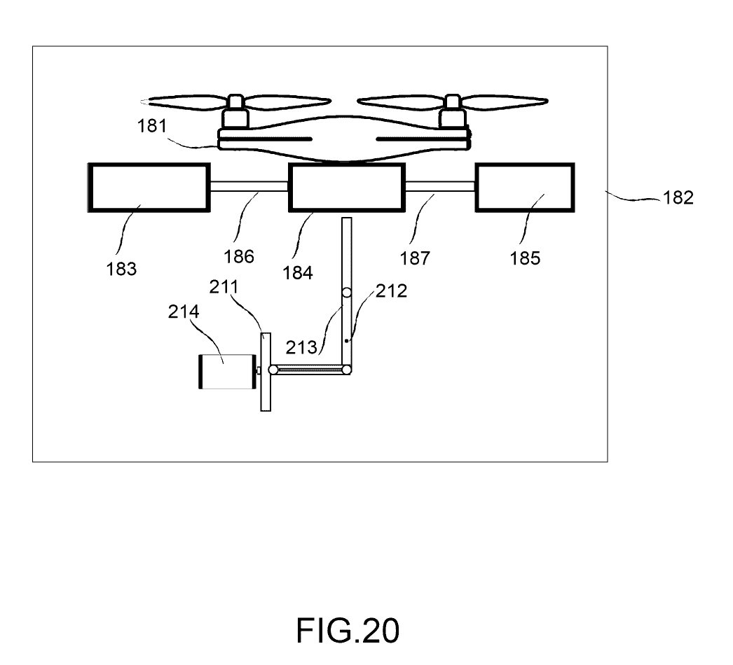

In FIG. 20, extension module 182 has been reconfigured to a cleaning extension module with small brushes for small spaces. Distance sensors 212 are located on each side of a metal arm 213. Also shown are a small brush 214. Distance sensor 21 is implemented for example using a 3D sensor or another sensor optimized to detect sizes of small spaces.

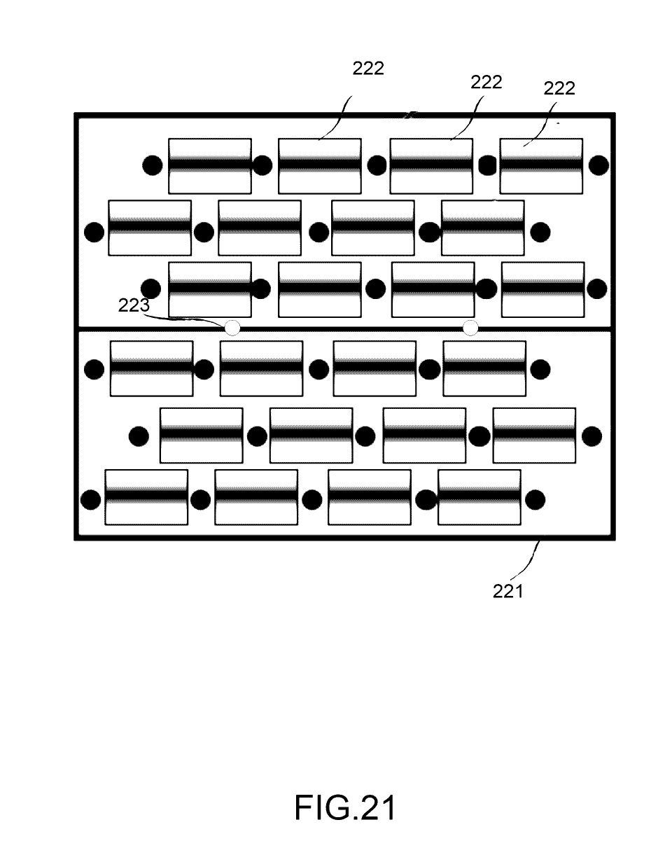

In FIG. 21, a vehicle cleaning extension module 221 has an array of big replaceable brushes 222 and a liquid spray nozzle 223 that sprays washing liquid.

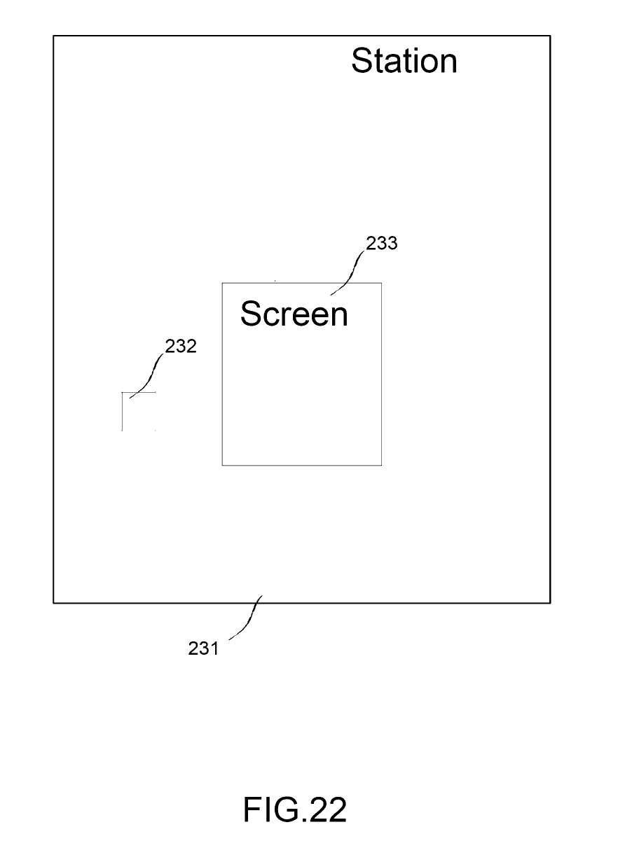

In FIG. 22, a station 231 includes a screen 233 on a surface of station 231 that can be useful to communicate with a customer to receive customer orders as well as to advertise services available from robots available through customer interactions with station 231. A close range wireless communication protocol device 232, such as a Bluetooth communication protocol device, can be used by a customer to request services from their computer device.

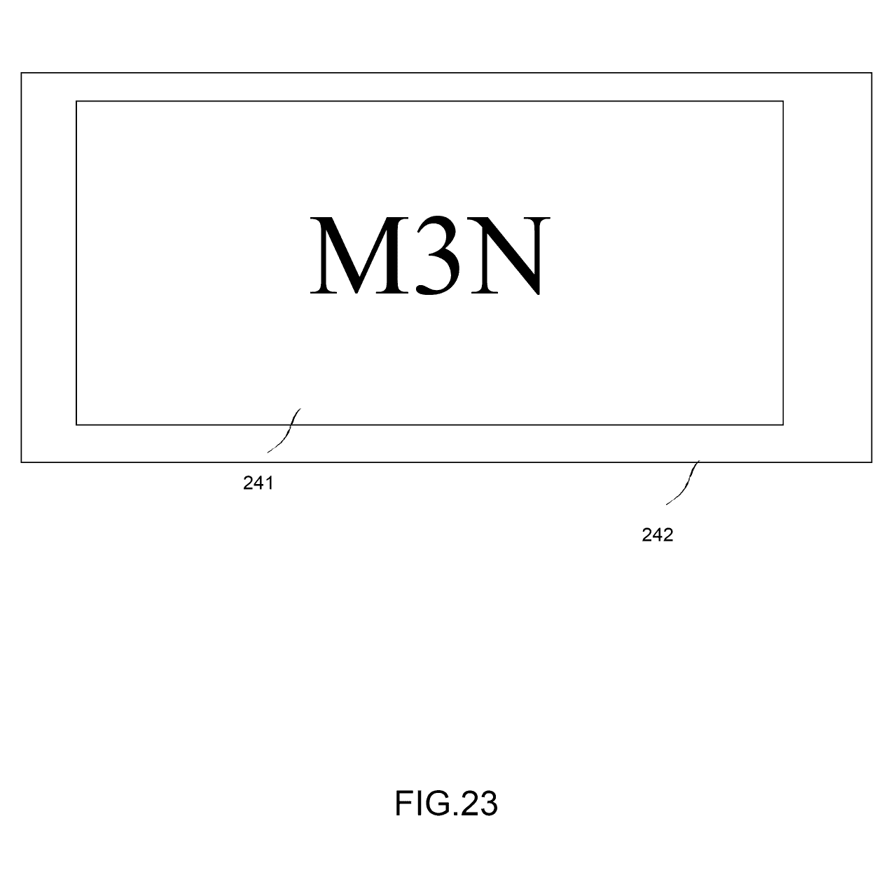

In FIG. 23, a sales/advertising module 241 includes a display screen 242. Display screen 242 can be used, for example, to deliver advertisements. For example, sales/advertising module 241 is attached to a robot and used to display advertisements at various locations. For example, the advertisement changes with locations of the robot and with time and date. For example, if when the robot location is above New York city, the advertisement can target New Yorkers. when the robot location is above San Francisco, the robot can target residents of San Francisco residents, and so on. For example, display screen 242 is implemented using LCD, LED or another screen technology.

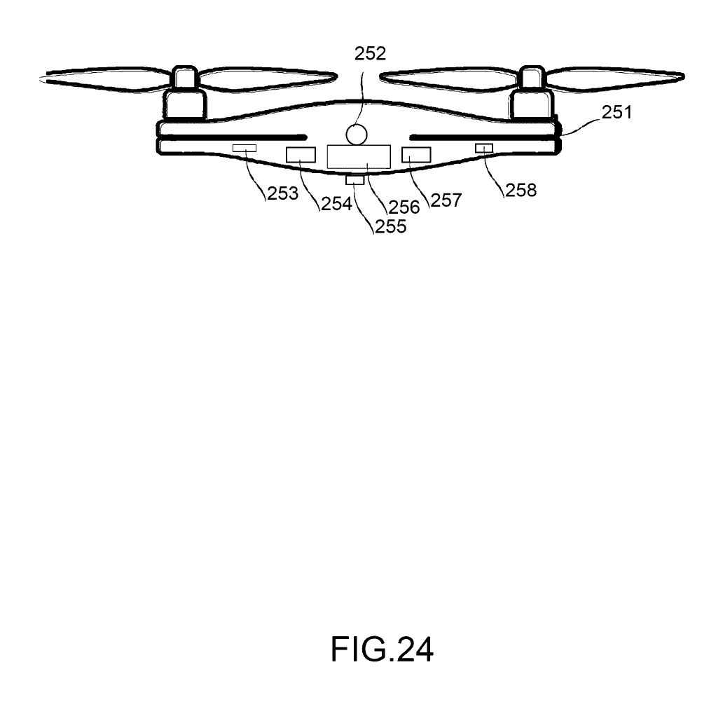

FIG. 24 gives an example of a sales robot 251 useful for communicating services and receiving payments from customers. Sales robot 251 includes a limited range network 254 to communicate with customers and allow them to pay using their computer devices. For example, limited range network 254 is a Near Field Communication (NFC) or similar network. For example, sales robot 251 can be called to a customer location. The customer can use a computing device such as a smart phone to communicate over limited range network 254 and make payments and provide instructions to sales robot 251. Alternatively, sales robot 251 can include a voice recognition device, credit card scanner or other communication device to receive orders, payments or other communications from a customer

For example, sales robot 251 includes a display screen 256 to present information to customers. For example, sales robot 251 also includes speakers 258, an optional dirt sensor 255, a camera 252, and lights 257 for night or unclear vision. A small range communication device 253 is used to let customers request services using their computer devices. For example, a robot acts like a sales person, so customers pay and request services from the robot at the customer location. Sales robot 251 can also be used for other purposes such as to check for correct parking configurations, for example, to check if customers park correctly with enough distances from all obstacles such as cars. Sales robot 251 can be implemented, for example using commonly available computer device components and communication chip such as 4g network to communicate with control system 14 and stations.

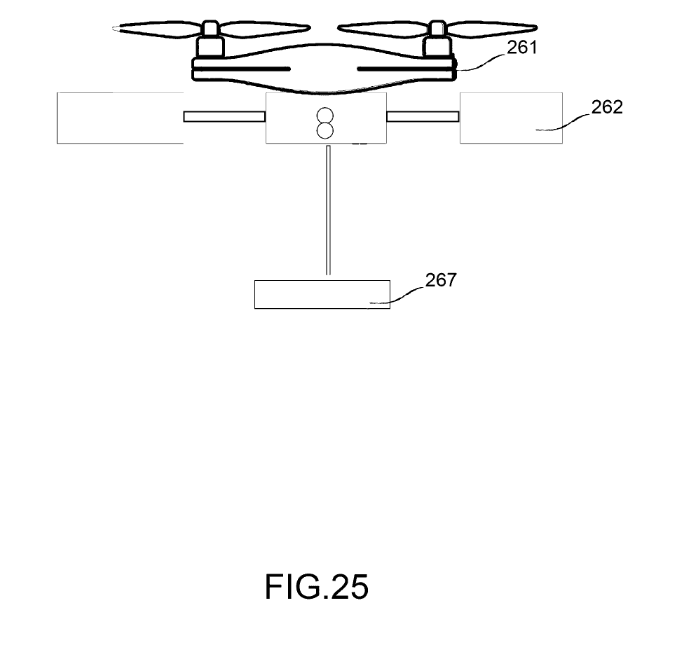

FIG. 25 shows a robot 261 attached to a vehicle cleaning extension module 262. Extension module 262 includes a dirt sensor 267. The purpose of dirt sensor 267 is to check vehicles to be washed to determine a dirt level based on how dirty the vehicles are. The information provided is used to determine a selected methodology to clean a vehicle based on the vehicle's determined dirt level. A dirt sensor can be included in a cleaning module or implemented in a separate dirt sensor module.

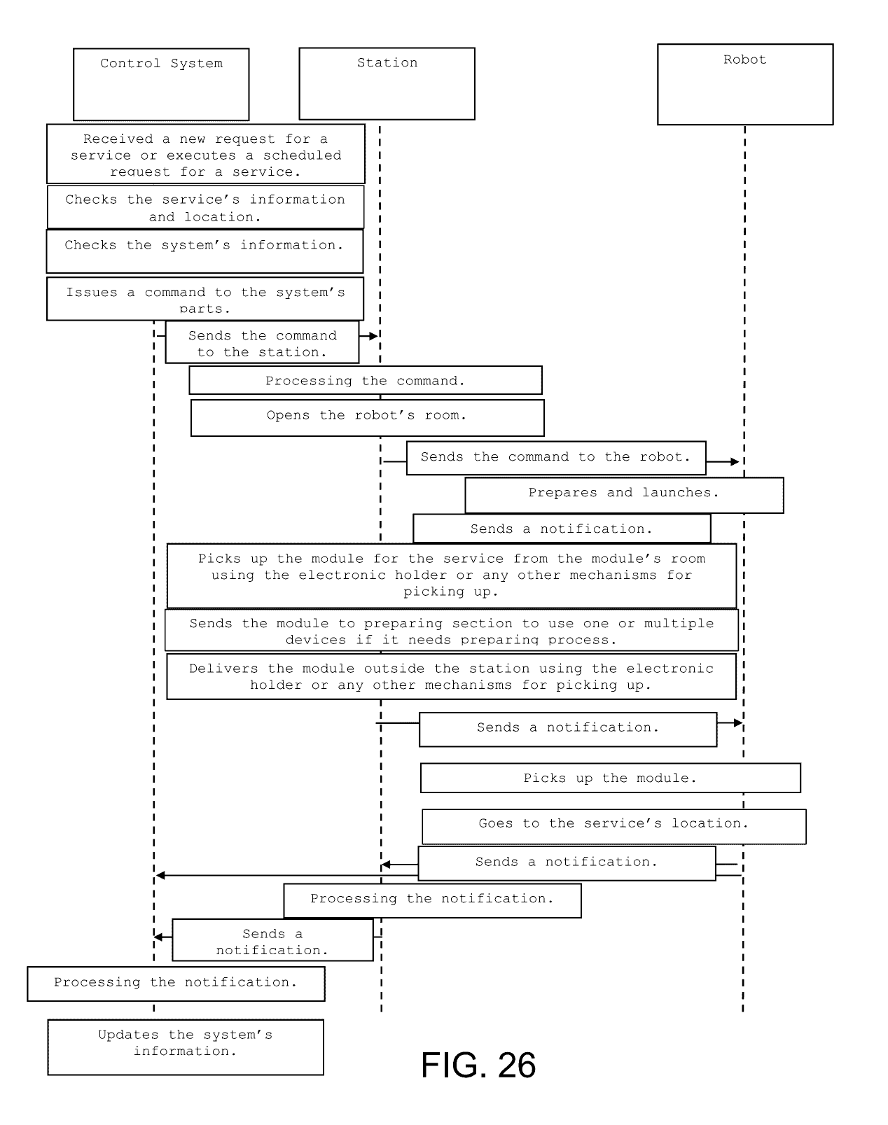

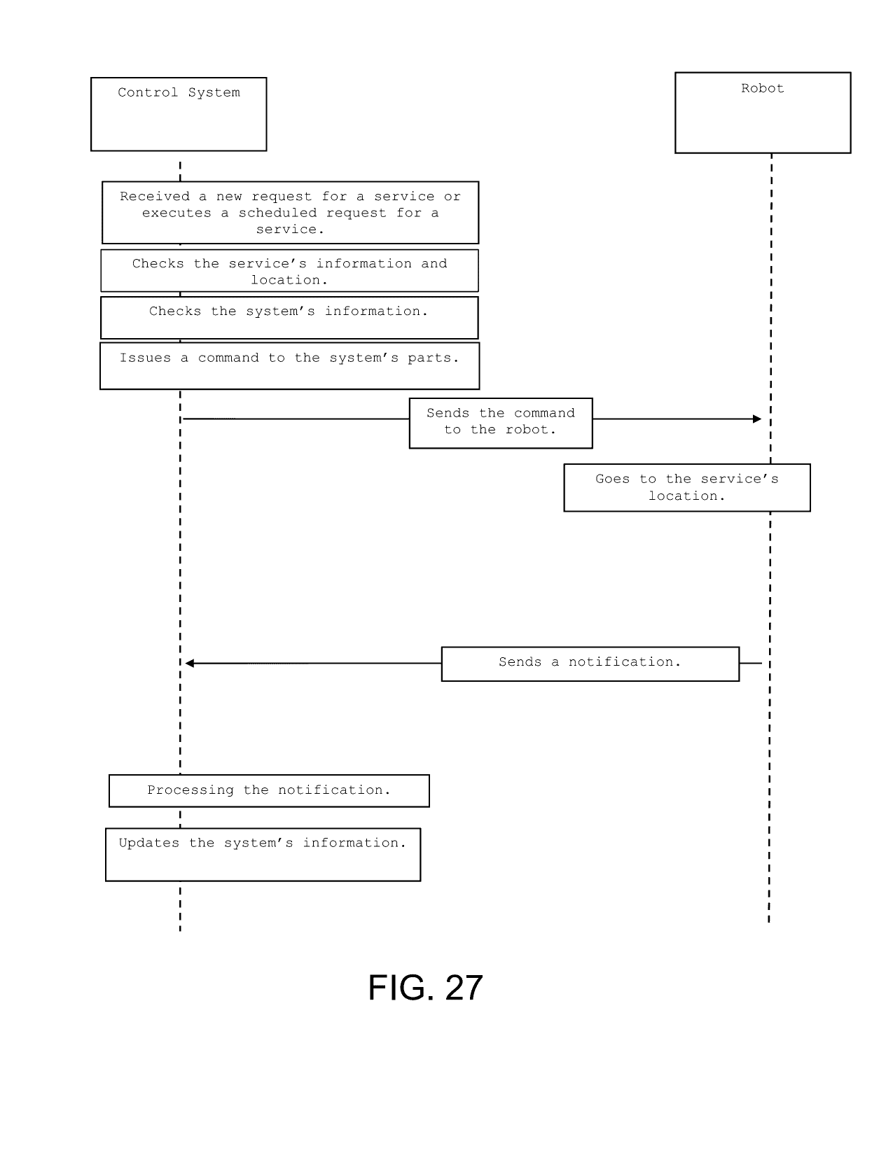

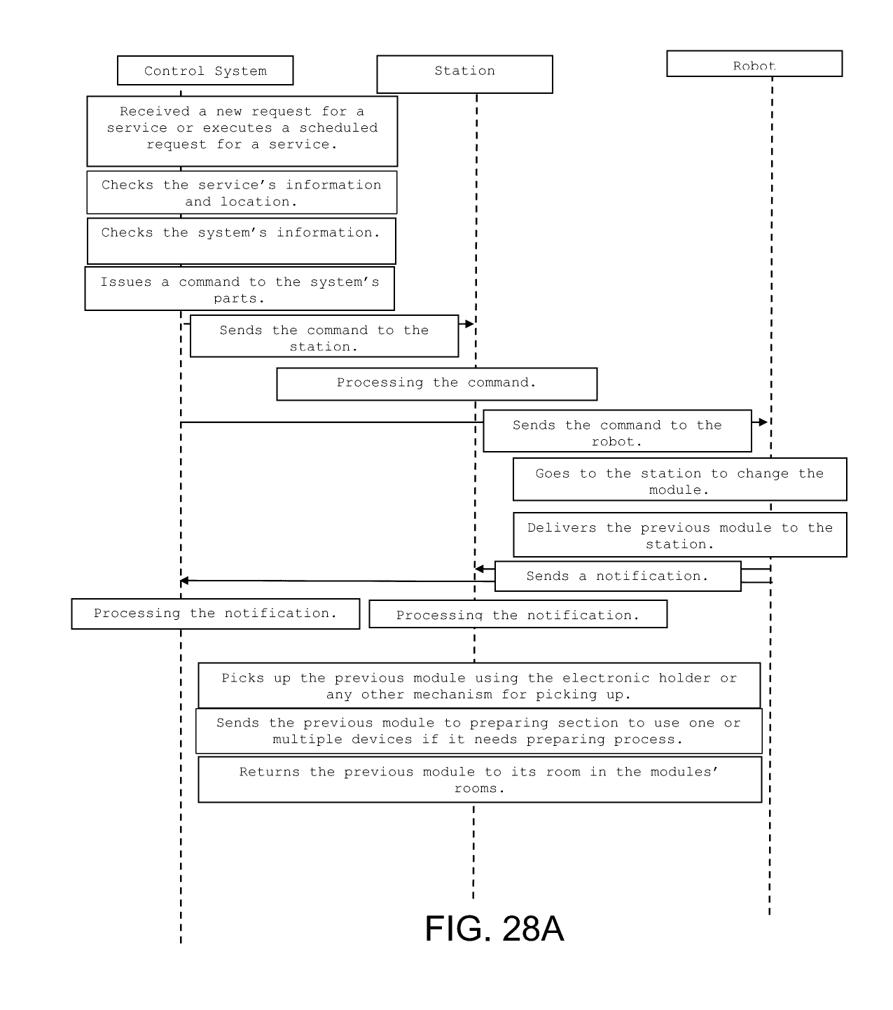

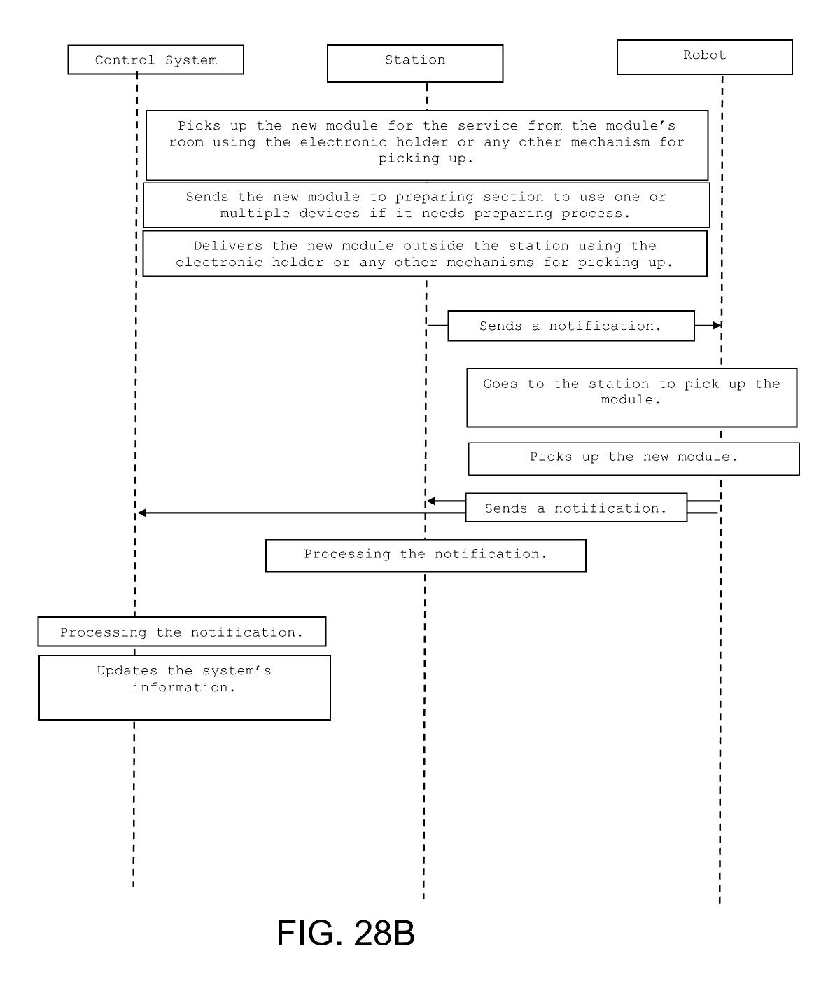

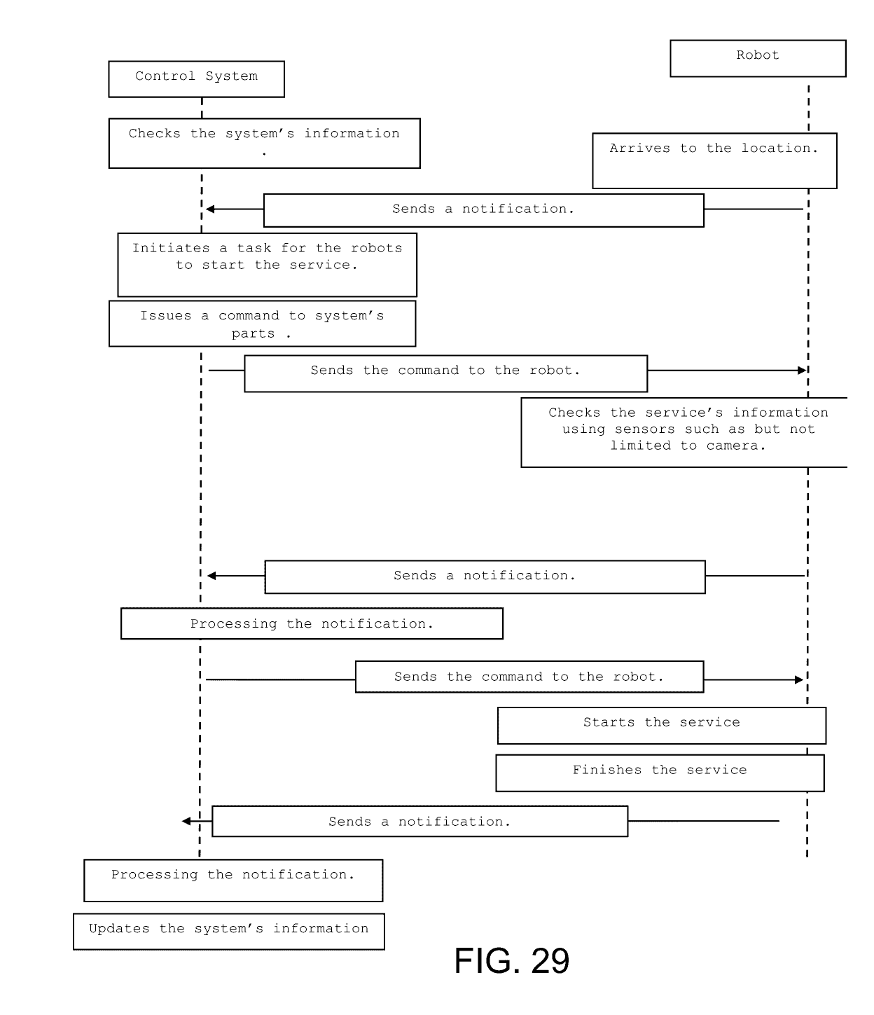

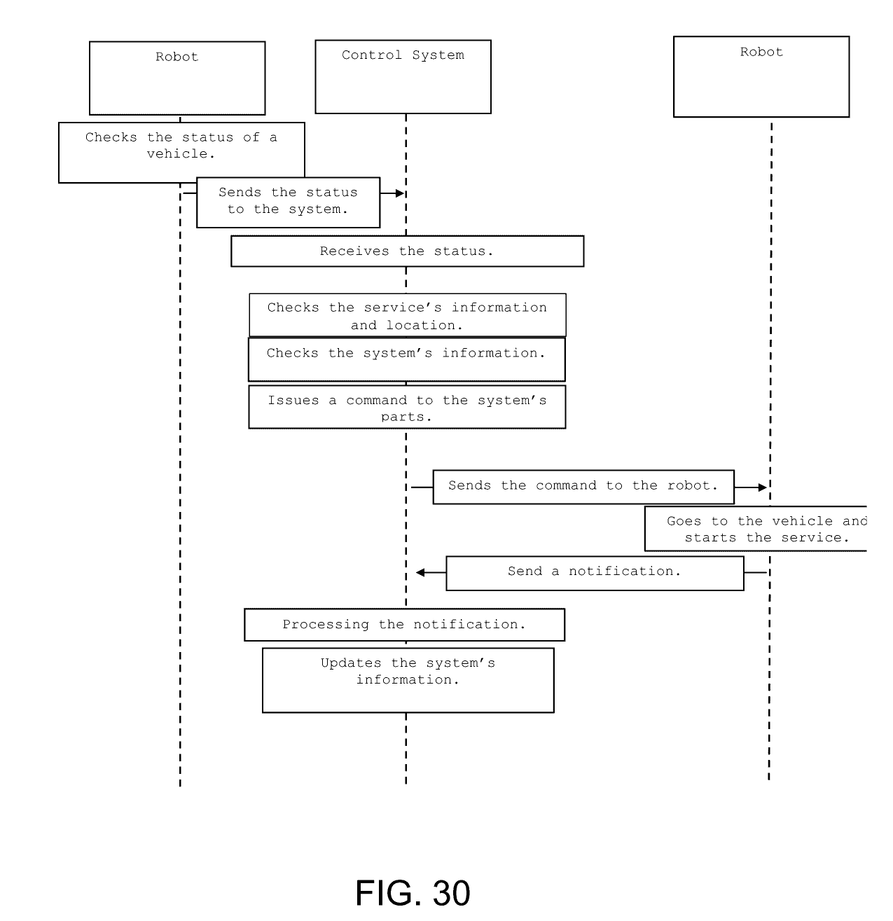

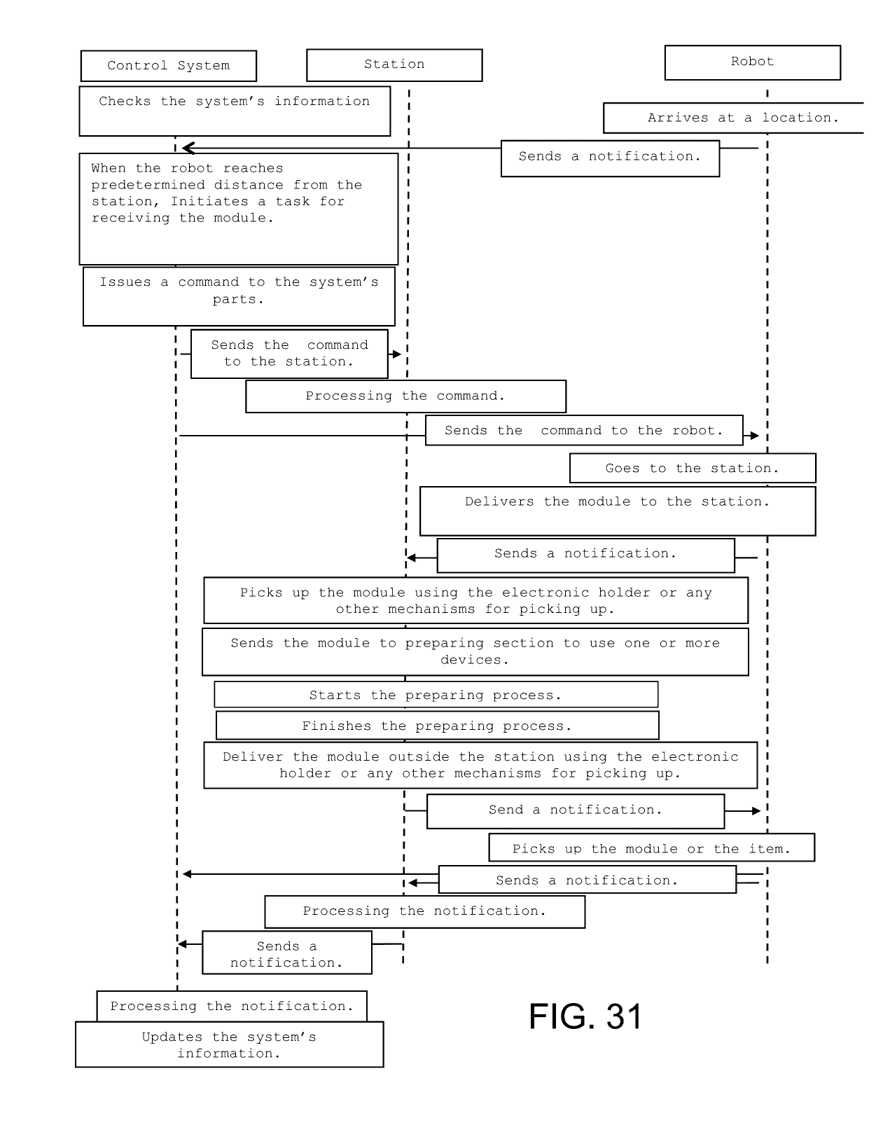

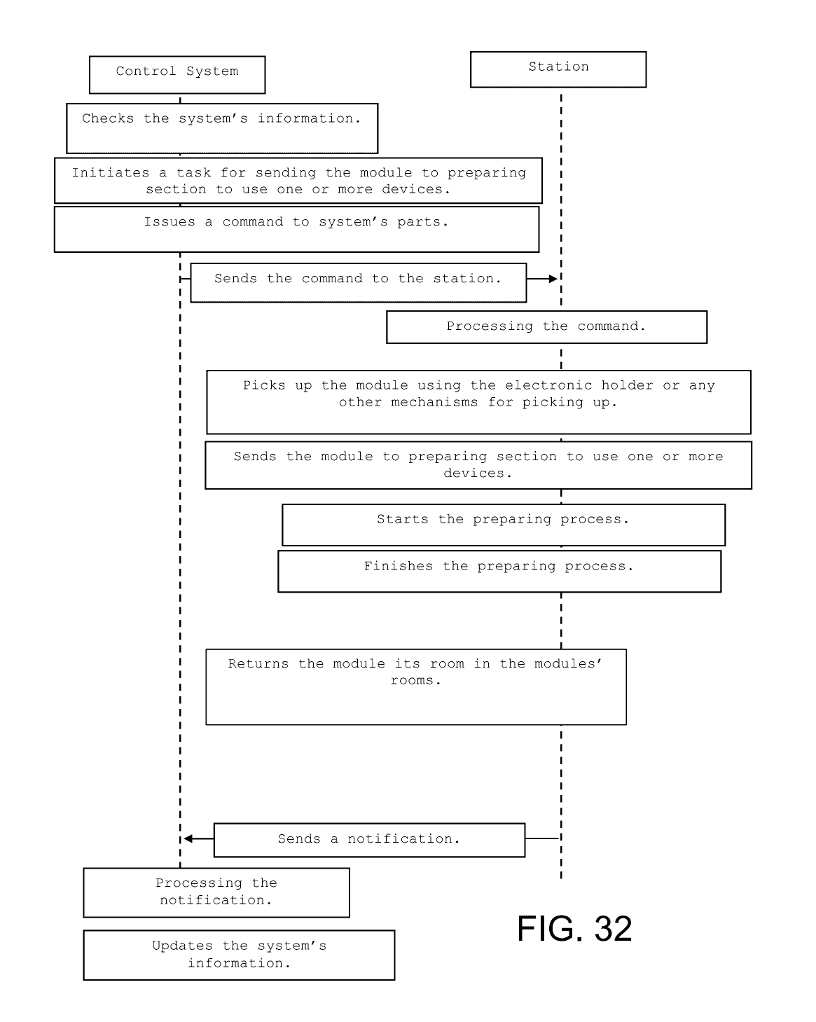

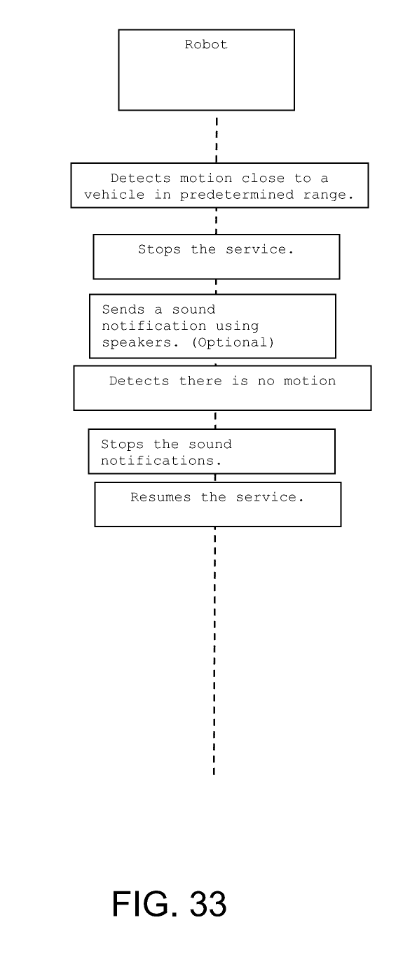

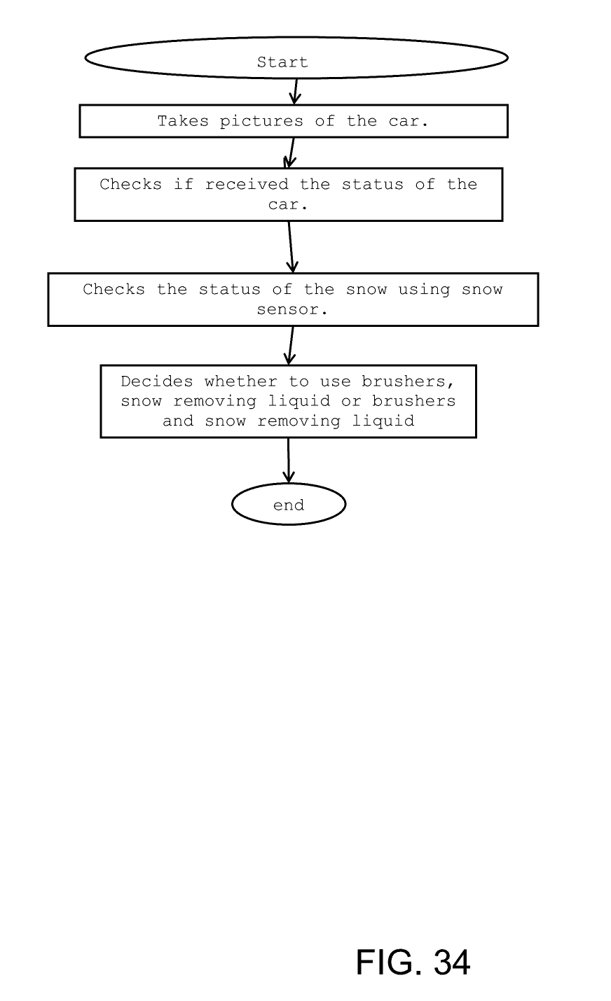

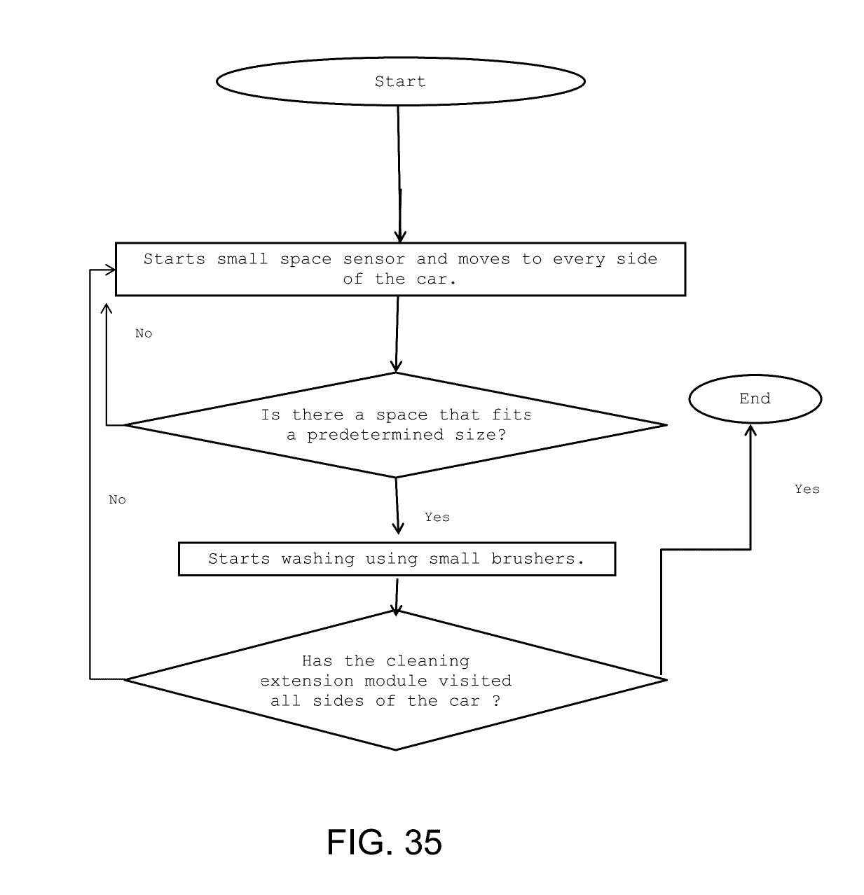

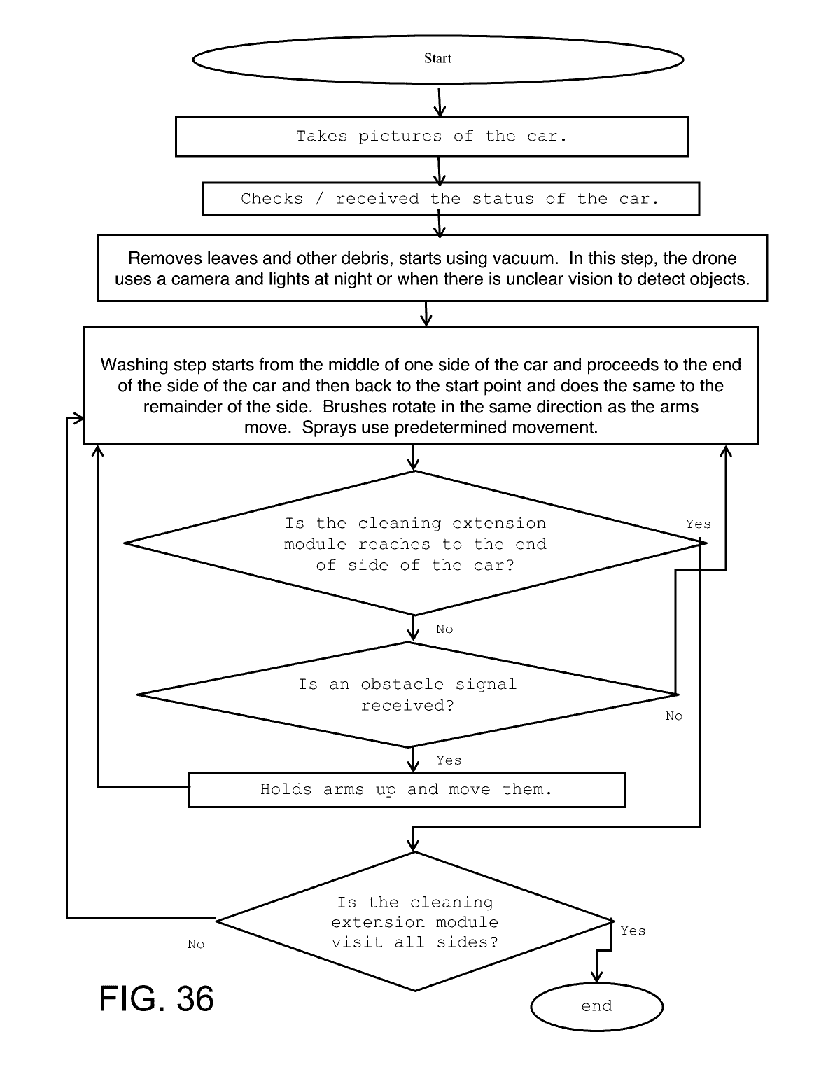

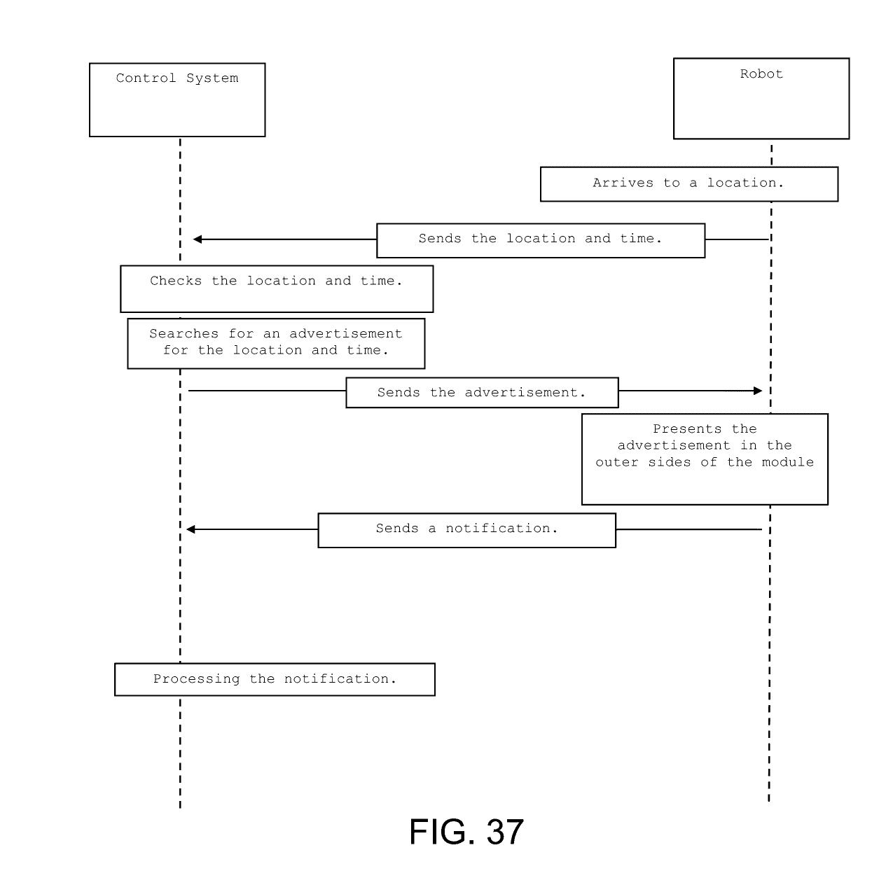

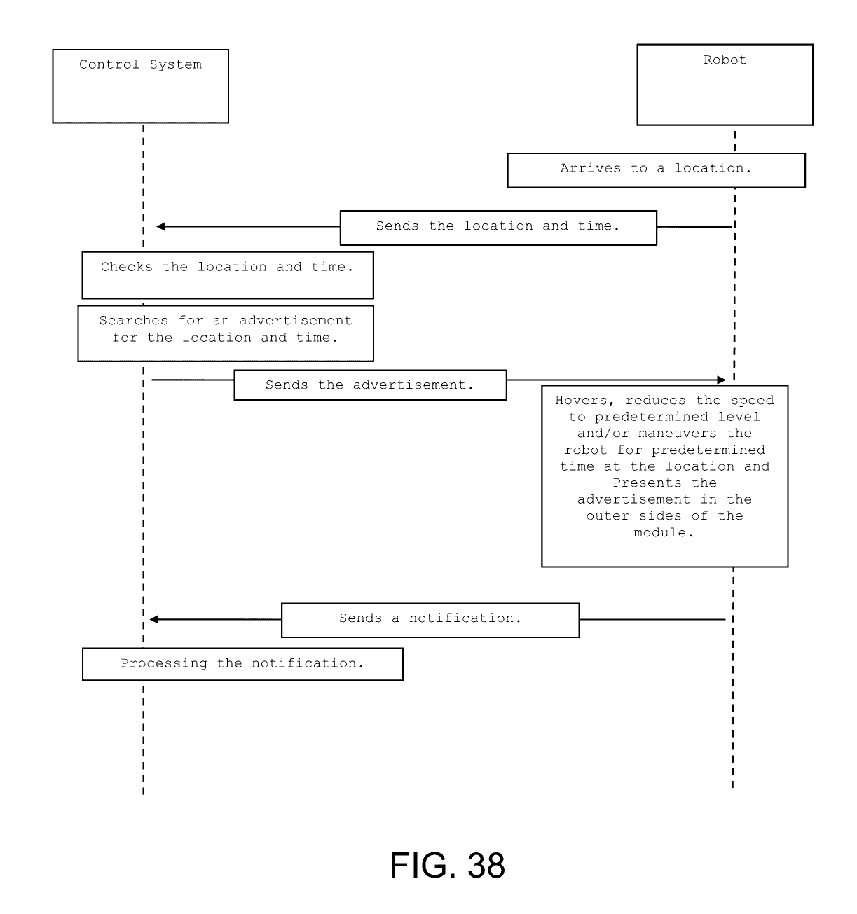

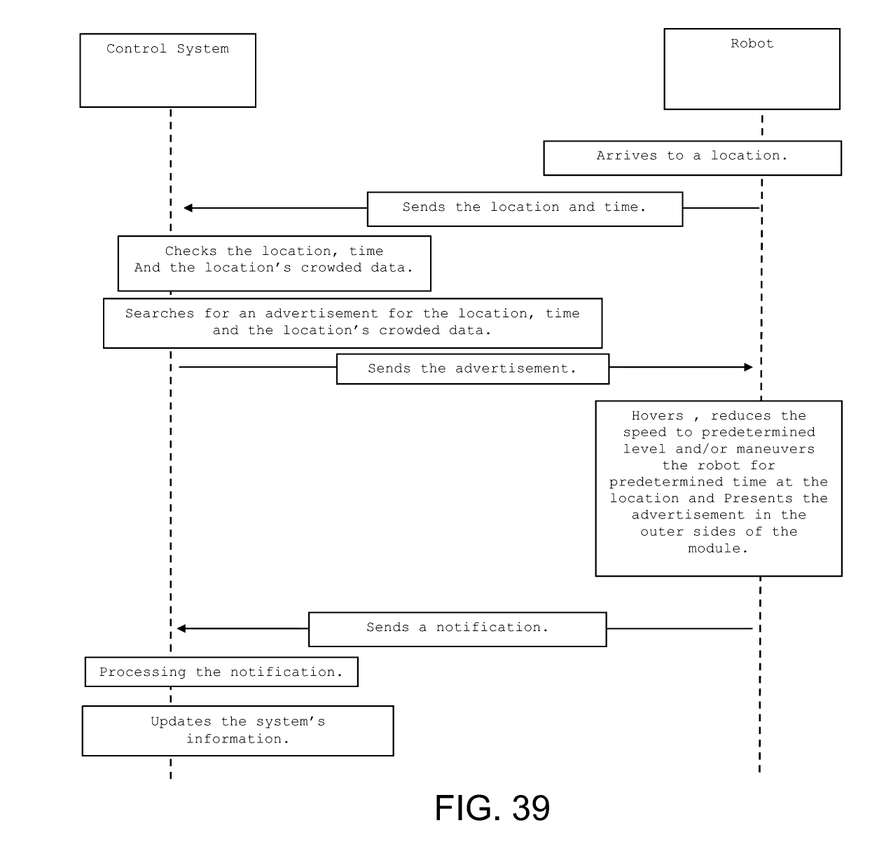

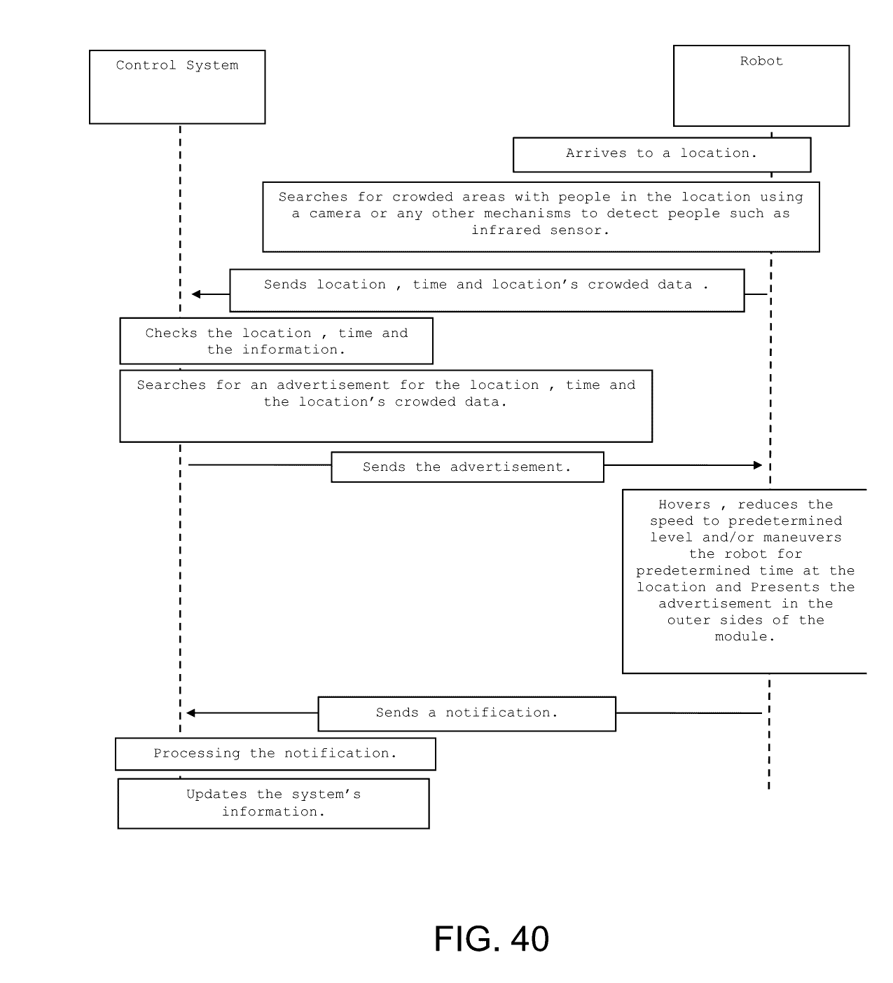

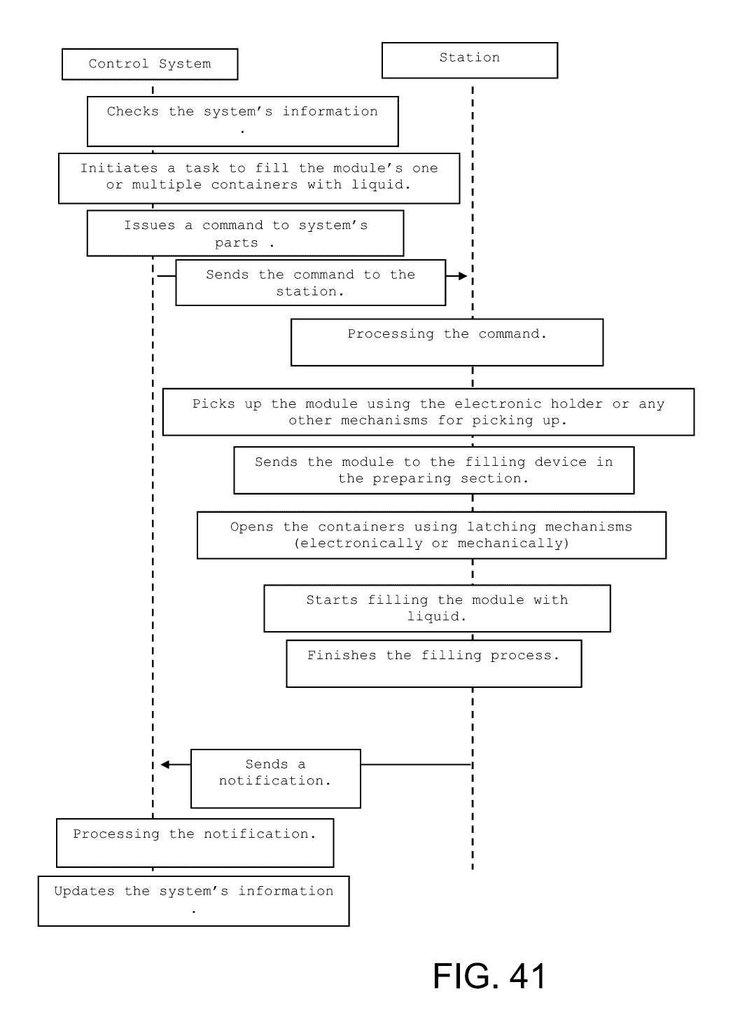

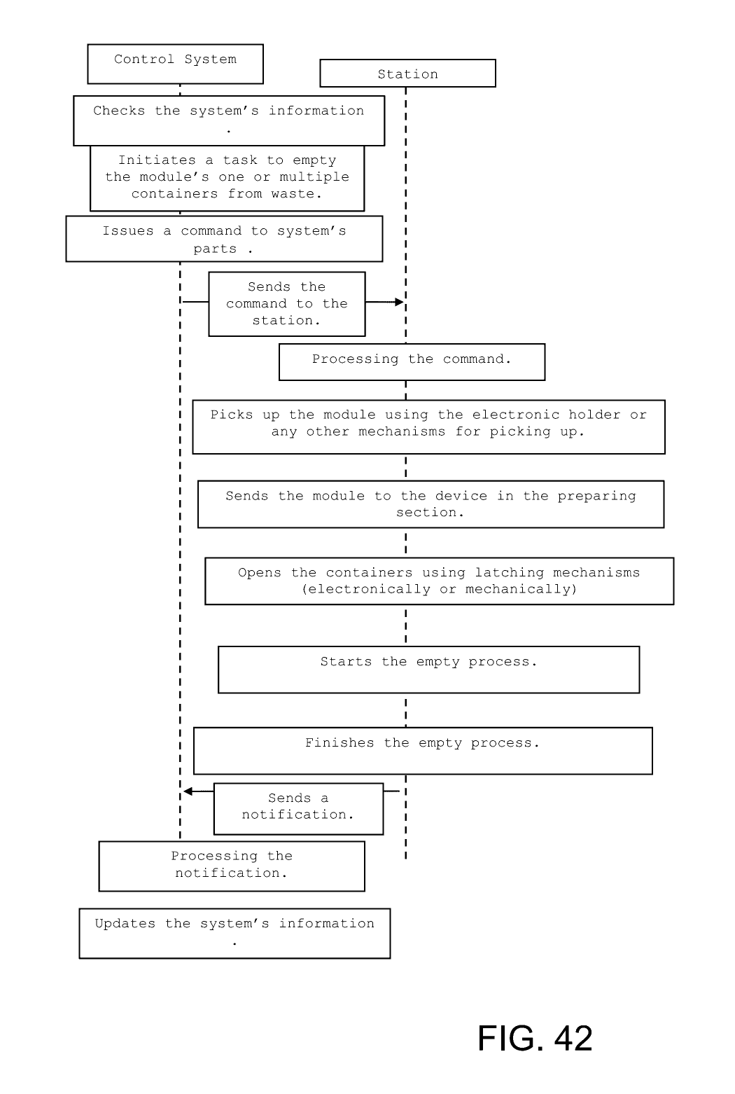

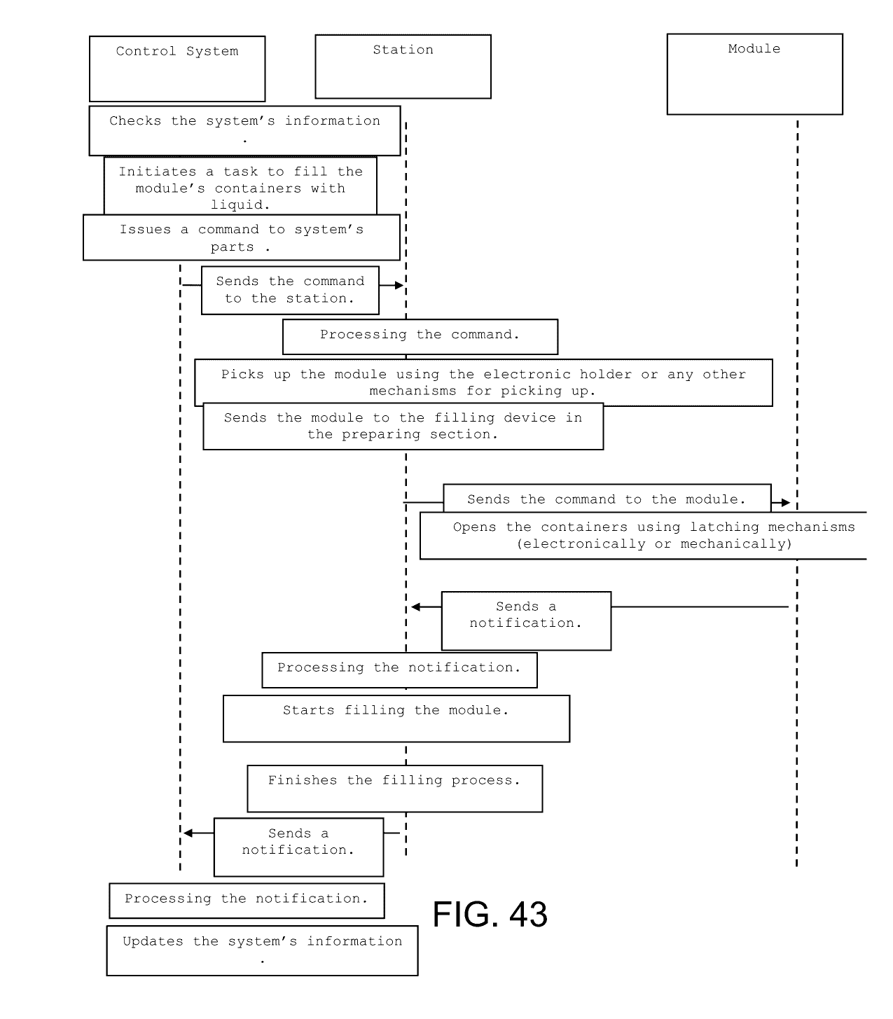

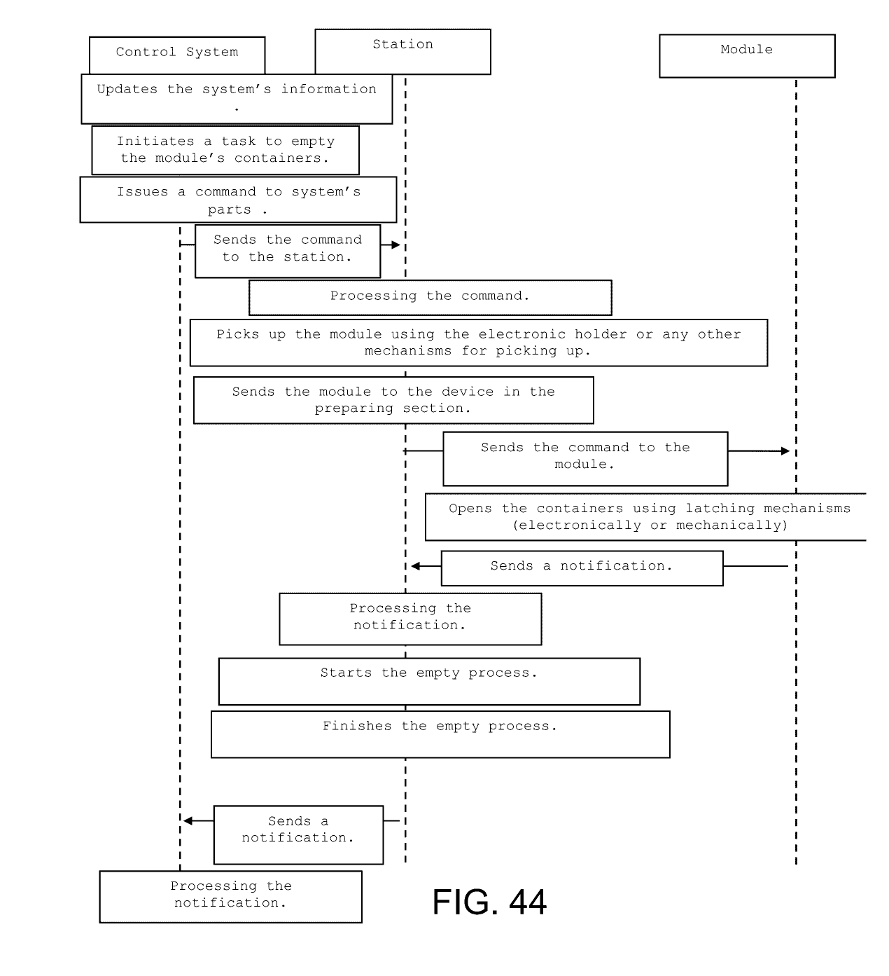

FIGS. 26 through 44 shows flowcharts for performing various tasks within a multipurpose robotic system. FIG. 26 is a simplified flowchart for a system that receives a new request or executes a scheduled request.

FIG. 27 is a simplified flowchart for a system that receives a request or executes a request and sends the request to a robot that is currently out of a station. FIG. 28A and FIG. 28B are a simplified flowchart for a system that changes a module for a robot.

FIG. 29 is a simplified flowchart for a system that sends a robot to a service location to start a service. FIG. 30 is a simplified exemplary flowchart for a robot that sends a notification about a situation to another robot.

FIG. 31 and FIG. 32 are simplified flowchart pertaining to delivery and pickup of modules and other items as part of a preparing process.

FIG. 33 is a simplified flowchart for a robot that detects motion around vehicles.

FIG. 34 is a simplified flowchart for a process to remove snow from vehicles.

FIG. 35 is a simplified flowchart for a process to wash a vehicle using small brushers. FIG. 36 is a simplified for flowchart a process to a vehicle using big brushers.

FIG. 37 is a simplified flowchart for a system that sends an advertisement to a module to present the advertisement on sides of the module.

FIG. 38 is a simplified flowchart for a system that sends an advertisement to a module to present the advertisement on sides of the module. The robot can hover, reduce the speed to a predetermined level and/or maneuver for a predetermined time at a particular location.

FIG. 39 is a simplified flowchart for a system that sends an advertisement to a module to present the advertisement in the outer sides of the module. The robot can hover, reduce the speed to a predetermined level and/or maneuver for a predetermined time at a particular location. The system searches for the advertisement using historical data about the crowdedness at the location.

FIG. 40 is a simplified flowchart for a system that sends an advertisement to a module to present the advertisement on the sides of a module. The robot can hover, reduce the speed to a predetermined level and/or maneuver for a predetermined time at a crowded location after finding the crowded location using camera or any sensor to detect locations crowded with people.

FIG. 41 is a simplified flowchart for a system that sends a module to be filled with liquid. FIG. 42 is a simplified flowchart for a system that sends a module to be emptied of waste.

FIG. 43 is a simplified flowchart for a system that sends a module to be filled with liquid. FIG. 44 is a simplified flowchart for a system that sends a module to be emptied of waste.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A multipurpose robotic system comprising:
an unmanned aerial vehicle that is able to fly under its own power to a location of a parked vehicle;
a cleaning module, the cleaning module being attachable to the unmanned aerial vehicle, the cleaning module being configured to take part in cleaning the parked vehicle, the cleaning module including a rotating brush configured to clean the vehicle.

2. A multipurpose robotic system as in claim 1 wherein the cleaning module includes a plurality of rotating brushes.

3. A multipurpose robotic system as in claim 1 wherein the cleaning module is magnetically attached to the unmanned aerial vehicle.

4. A multipurpose robotic system as in claim 1 wherein the cleaning module is mechanically attached to the unmanned aerial vehicle.

5. A multipurpose robotic system as in claim 1 wherein the cleaning module includes a liquid spray nozzle that sprays washing liquid.

6. A multipurpose robotic system as in claim 1 wherein the cleaning module additionally includes:
moveably adjustable arms that mechanically adjust position of the rotating brush with respect to a base of the cleaning module attached to the unmanned aerial vehicle.

7. A multipurpose robotic system as in claim 1 wherein the cleaning module additionally includes a vacuum device.

8. A multipurpose robotic system as in claim 1 wherein the cleaning module additionally includes a dirt sensor used to determine a level of vehicle dirtiness.

9. A multipurpose robotic system as in claim 1 wherein the cleaning module additionally includes a snow sensor used to detect amount of snow on vehicle.

10. A multipurpose robotic system as in claim 1 additionally comprising:
additional unmanned aerial vehicles that are able to fly under its own power to a location of a parked vehicle;
additional cleaning modules being attachable to the additional unmanned aerial vehicle.

11. A multipurpose robotic system as in claim 11 comprising:
an unmanned aerial vehicle that is able to fly under its own power to a location of customer;
a sales module, the sales module being attachable to the unmanned aerial vehicle, the sales module being configured to engage in commercial transactions with the customers, including receiving payments from the customers, the sales module including:
a display screen for displaying information to the customers; and,
a communication device for receiving payment information from the customers.

12. A multipurpose robotic system as in claim 11, wherein the communication device is a limited range network that communicates with a computing device of the customer.

13. A multipurpose robotic system as in claim 11, wherein the communication device includes a voice recognition system that receives payment information through voice communication.

14. A multipurpose robotic system as in claim 11, wherein the communication device includes a voice recognition system that receives payment information through voice communication.

15. A multipurpose robotic system as in claim 11, wherein the sales module includes sensors that are capable of recognizing parking patterns of vehicles.

16. A multipurpose robotic system as in claim 11, wherein the display screen displays targeted advertisements.

17. A multipurpose robotic system as in claim 11, wherein the sales module receives requests for service.

18. A multipurpose robotic system comprising:
an unmanned aerial vehicle that is able to fly under its own power to a location of a parked vehicle;
a vacuum module, the vacuum module being attachable to the unmanned aerial vehicle, the vacuum module including a vacuum cleaner able to aid in cleaning vehicles or ground areas.

19. A multipurpose robotic system as in claim 18 wherein the vacuum module includes a liquid spray nozzle that sprays washing liquid.

20. A multipurpose robotic system as in claim 18 wherein the vacuum module additionally includes a dirt sensor used to determine a level of vehicle dirtiness.
